(19) United States
(12) Patent Application Publication
(10) Pub. No.: US 2008/0228738 A1
(43) Pub. Date: Sep. 18, 2008

(54) WEB BASED OPEN KNOWLEDGE SYSTEM WITH USER-EDITABLE ATTRIBUTES

(75) Inventor: Bicheng Li, Jiangsu (CN)

Correspondence Address: TILLMAN WRIGHT, PLLC, PO BOX 471581, CHARLOTTE, NC, 28247, US

(73) Assignee: WISTEME, LLC, Cary, NC (US)

(21) Appl. No.: 12/118,733

(22) Filed: May 11, 2008

Related U.S. Application Data
(63) Continuation-in-part of application No. PCT/CN2006/003336, filed on Dec. 8, 2006.
Application No. PCT/CN2006/003336 is a continuation-in-part of application No. PCT/CN2007/002446, filed on Aug. 14, 2007.

(30) Foreign Application Priority Data
Dec. 13, 2005 (CN) 200510123001.6
Aug. 25, 2006 (CN) 200610088491.5

(51) Int. Cl. G06F 7/06; G06F 17/30

(52) U.S. Cl. 707/3; 707/E17.014

(57) ABSTRACT

A method of providing an open knowledge system includes: providing, via network communications, access by users to the open knowledge system; searching the open knowledge system for informational content by comparing metadata in the open knowledge system with user-specified search data, the metadata in the open knowledge system representing particular topics for which informational content is stored in the open knowledge system; presenting informational content for view by the users, the informational content resulting from the searching based on the comparison of the metadata with the user-specified search data; and enabling users to modify the metadata in the open knowledge system that represents the presented informational content resulting from the searching based on the comparison of the metadata with the user-specified search data. Relevant informational content thereby may be more readily viewed as a result of the searching by comparing metadata with user-specified search data.

### CROSS-REFERENCE TO RELATED APPLICATION

The present application is:
(1) a U.S. Continuation-In-Part patent application of, and claims domestic priority under 35 U.S.C. §120 to, International Patent Application Serial No. PCT/CN2006/003336, filed Dec. 8, 2006, which designates the United States and which published as WO 2007/068190, and which International Patent Application claims foreign priority under 35 U.S.C. §119 to Chinese Patent Application Serial No. 200510123001.6, filed Dec. 13, 2005; and
(2) a U.S. Continuation-In-Part patent application of, and claims domestic priority under §120 to, International Patent Application Serial No. PCT/CN2007/002446, filed Aug. 14, 2007, which designates the United States and which published as WO 2008/025229, and which International Patent Application claims foreign priority under §119 to Chinese Patent Application Serial No. 200610088491.5, filed Aug. 25, 2006.

Each of these patent applications and patent application publications is hereby incorporated herein by reference. Furthermore, an English translation of WO 2007/068190 can be found in Appendix B attached hereto, and an English translation of WO 2008/025229 can be found in Appendix C attached hereto, both of which are hereby incorporated herein by reference. Additionally, a white paper document entitled “Wisteme—Wisdom System for Everyone” is attached hereto as Appendix A, and is hereby incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to web based open knowledge systems, including open knowledge systems with user-editable attributes; open knowledge systems with advertisement awards provided to contributors; and open knowledge systems with both user-editable attributes and advertisement awards provided to contributors.

Historically, most knowledge systems have tended to be closed knowledge systems. Traditional encyclopedias and textbooks are a good example of closed knowledge systems. These systems are considered to be closed because they are updated very infrequently. In contrast, in “open knowledge” systems, users of the system can and are encouraged to add to and modify information in the system on an ongoing basis, whereby the information in the system continuously grows.

A self-oriented knowledge system may be considered a type of open knowledge system. The world wide web is perhaps the best example of such a self-oriented knowledge system. The world wide web has a vast amount of information that has usually been compiled without any thought as to what knowledge any one particular user may be seeking. As such, a user is left to search the knowledge system himself, i.e., he must orient himself within the vast knowledge system.

Internet forums and message boards represent more common and understood types of open knowledge systems. In Internet forums and message boards, users are free to ask questions or contribute their own knowledge to the system. Users can post messages, and other users can reply to posted messages with posts of their own. Most message boards today group together a first post on a subject and any subsequent replies to that post, which sequence often is referred to as a “thread.” These threads may be organized by subject matter to facilitate finding of information of interest to the users.

A “Wiki” represents another type of open knowledge system. In these systems, users post, edit, and make changes to the content of web pages that collectively make up the Wiki. Perhaps the most widely known such Wiki is Wikipedia, which currently can be found at http://www.wikipedia.com. The information at Wikipedia is searchable, and information pertaining to a particular subject matter is presented in similar fashion to an encyclopedia. Another Wiki is “WikiAnswers,” which currently can be found at http://www.wikianswers.com. This Wiki formats the information provided in the form of questions and answers. Users may both post questions to be answered by other users at WikiAnswers, and post and edit answers to questions that are posted at WikiAnswers from other users.

The present invention represents a still yet improved open knowledge system.

### SUMMARY OF THE INVENTION

The present invention includes many aspects and features. Moreover, while many aspects and features relate to, and are described in, the context of web based open knowledge systems, the present invention is not limited to use only in such systems, as will become apparent from the following summaries and detailed descriptions of aspects, features, and one or more embodiments of the present invention.

Accordingly, one aspect of the present invention relates to a method for an open knowledge system that includes the steps of providing, via network communications, access by users to the open knowledge system; searching the open knowledge system for informational content by comparing attributes of records stored in the open knowledge system with search data that is specified by the users, the records in the open knowledge system representing particular topics for which informational content is stored in the open knowledge system; presenting informational content of records for view by the users, the informational content resulting from the searching based on the comparison of the attributes with the user-specified data; and enabling users to modify the attributes of the records in the open knowledge system that represent the presented informational content resulting from the searching based on the comparison of the attributes with the user-specified data. Relevant informational content thereby may be more readily viewed as a result of the searching of the open knowledge system by comparing attributes of records in the open knowledge system with user-specified search data.

In features of this aspect, the particular topics are presented in the format of questions and the informational content is presented in the format of answers. Furthermore, the attributes for a record representing a particular topic that may be modified by users include: metadata representing the question and answer (e.g., keywords of the question and answer); the type of the question (e.g., how, what, when, where, who, why); the category of the particular topic; and the status of the question (i.e., whether the a question has been answered).

Another aspect of the present invention relates to a method for an open knowledge system that includes the steps of providing, via network communications, access by users to the open knowledge system; searching the open knowledge system for informational content by comparing metadata in the open knowledge system with user-specified search data, the metadata in the open knowledge system representing particular topics for which informational content is stored in the open knowledge system; presenting informational content for view by the users, the informational content resulting from the searching based on the comparison of the metadata with user-specified search data; and enabling users to modify the metadata in the open knowledge system that represents the presented informational content resulting from the searching based on the comparison of the metadata with the user-specified search data. Relevant informational content thereby may be more readily viewed as a result of the searching of the open knowledge system by comparing metadata in the open knowledge system with user-specified search data.

In a feature of this aspect, the metadata comprises a plurality of descriptors of the particular topic to which the viewed informational content pertains.

In a feature of this aspect, users can both add and delete descriptors.

In a feature of this aspect, a descriptor comprises a noun.

In a feature of this aspect, a descriptor comprises a proper noun.

In a feature of this aspect, a descriptor comprises a name.

In a feature of this aspect, a descriptor comprises a URL.

In a feature of this aspect, a descriptor comprises an address.

In a feature of this aspect, a descriptor comprises an adjective.

In a feature of this aspect, the method further includes the step of enabling users to modify informational content that is presented, whereby the presented informational content may be updated by users.

In a feature of this aspect, users can modify informational content by uploading data representing the modified informational content.

In a feature of this aspect, the particular topics are presented to users in the form of questions. Furthermore, the metadata may comprise a plurality of descriptors, and the descriptors may comprise keywords of the question.

In another feature of this aspect, informational content is presented to users in the form of answers. Furthermore, the metadata may comprise a plurality of descriptors, and the descriptors may comprise keywords of answers.

In a feature of this aspect, the method further includes computer-executable instructions in computer-readable medium for providing a user interface by which the plurality of users can add new records that are stored in the database, each new record including a data structure comprising a primary data component that is configured to store primary data of the new record, the primary data representing a particular topic; and a plurality of secondary data components, at least one of the secondary data components being configured to store informational content pertaining to the particular topic represented by the primary data of the new record, and at least another of the secondary data components being configured to store metadata representing a plurality of descriptors of the particular topic represented by the primary data of the new record.

In a feature of this aspect, each record further includes a secondary data component configured to store data representing a unique database identification number logically associated with the record.

In a feature of this aspect, each record further includes a secondary data component configured to store data representing a category of the particular topic of the record.

In a feature of this aspect, each record further includes a secondary data component configured to store data representing primary data that was previously stored in the primary data component but has since been modified or deleted.

In a feature of this aspect, each record further includes a secondary data component configured to store data representing informational content pertaining to the particular topic of the record, which informational content has since been modified by a user.

Another aspect of the invention relates to an open knowledge system. An exemplary such open knowledge system includes a plurality of records stored in a database in computer-readable medium that is accessible by a plurality of users via network communications. Furthermore, each of the plurality of records includes a data structure comprising a primary data component that is configured to store primary data of the record, the primary data representing a particular topic of the record, and a plurality of secondary data components of the record.

Additionally in this aspect, one of the secondary data components is configured to store informational content pertaining to the particular topic of the record, and one of the secondary data components is configured to store metadata representing a plurality of descriptors of the particular topic of the record, whereby users searching for the particular topic may locate the informational content of the record.

Furthermore, in this aspect of the invention, the open knowledge system also includes computer-executable instructions in computer-readable medium for providing a user interface by which the plurality of users can modify data stored in the records, including, for a record, modifying the primary data stored in the primary data component of the record, and the metadata stored in the secondary data component of the record, whereby informational content in the open knowledge system may be updated and more readily found as a result of user modifications of the records in the database.

In a feature of this aspect, the plurality of users further can modify, by the user interface, the informational content stored in the secondary data component of the record.

In a feature of this aspect, the user interface enables a user to both add and delete metadata including descriptors.

In a feature of this aspect, a descriptor comprises a noun.

In a feature of this aspect, a descriptor comprises a proper noun.

In a feature of this aspect, a descriptor comprises a name.

In a feature of this aspect, a descriptor comprises a URL.

In a feature of this aspect, a descriptor comprises an address.

In a feature of this aspect, a descriptor comprises an adjective.

In a feature of this aspect, the user interface enables a user to upload data representing informational content for adding a record.

In a feature of this aspect, the particular topics are presented to users in the form of questions. Furthermore, the metadata may comprise a plurality of descriptors, and the descriptors may comprise keywords of the question.

In another feature of this aspect, informational content is presented to users in the form of answers. Furthermore, the metadata may comprise a plurality of descriptors, and the descriptors may comprise keywords of answers.

In a feature of this aspect, the user interface includes an edit box, an edit field, a dropdown menu, an expandable menu, a file browser window, or a file attachment window.

In a feature of this aspect, the system further includes computer-executable instructions in computer-readable medium for providing a user interface by which the plurality of users can add new records to be stored in the database, each new record including a data structure comprising a primary data component that is configured to store primary data of the new record, the primary data representing a particular topic of the new record; and a plurality of secondary data components, at least one of the secondary data components being configured to store informational content pertaining to the particular topic of the new record, and at least another of the secondary data components being configured to store metadata representing a plurality of descriptors of the particular topic of the new record.

In a feature of this aspect, the data structure of a record stored in the database further includes a secondary data component configured to store data representing a unique database identification number logically associated with the record.

In a feature of this aspect, a record stored in the database further includes a secondary data component configured to store data representing a category of the particular topic represented by the primary data of the record.

In a feature of this aspect, a record stored in the database further includes a secondary data component configured to store data representing primary data that was previously stored in the primary data component of the record but has since been modified or deleted.

In a feature of this aspect, a record stored in the database further includes a secondary data component configured to store data representing informational content pertaining to the particular topic of the record, which informational content has since been modified by a user.

In a feature of this aspect, a record stored in the database further includes a secondary data component configured to store data representing user comments and discussion relating to the record and the data stored in a data component of the record.

In a feature of this aspect, a record stored in the database further includes a secondary data component configured to store data representing an identification of each user who has modified the record.

In a feature of this aspect, a record stored in the database further includes a secondary data component configured to store data representing browsing statistics of the informational content of the record.

In a feature of this aspect, a record stored in the database further includes a secondary data component configured to store data representing editing statistics relating to the record.

In a feature of this aspect, a record stored in the database further includes a secondary data component configured to store data representing degree-of-user-satisfaction statistics relating to the informational content of the record.

In a feature of this aspect, a record stored in the database further includes a secondary data component configured to store data representing urgency statistics (the urgency being the urgency in obtaining an answer for a question).

In a feature of this aspect, the network communications comprise Internet communications.

In a feature of this aspect, the user interface is presented within an Internet browser web page.

Other aspects and features of the present invention are set forth in the publications of the international patent applications, which have been incorporated herein by reference.

Additional aspects and features of the present invention are set forth in the document attached as Appendix A, titled “Wisteme—Wisdom System for Everyone”, which has been incorporated herein by reference.

Still other aspects of the invention relates to a computer-readable medium containing computer-executable instructions for performing a method in accordance with any of the foregoing aspects.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a block diagram of a data structure stored in computer-readable medium of a preferred embodiment of the present invention;

FIG. 2 is a schematic view of the architecture of a preferred embodiment of the present invention;

FIG. 3 is an illustration of a computer monitor displaying a log-in web page of the open knowledge system of a preferred embodiment of the present invention;

FIG. 4 is a screenshot of a home page of the open knowledge system of a preferred embodiment of the present invention.

FIG. 5 is a screenshot of a web page of the open knowledge system represented in FIG. 4 that represents an exemplary Search page 520;

FIG. 6 is a screenshot of the Search page 520 of FIG. 5, after a search has been effected for the keyword “patent”;

FIG. 7 is a screenshot of the Search page 520 of FIG. 6 demonstrating the use of one or more hints to refine a search;

FIG. 8 is a screenshot of the Search page 520 of FIG. 7, with a single result returned;

FIG. 9 is a screenshot of a web page of the open knowledge system represented in FIG. 4 that represents an exemplary question content page 540;

FIG. 10 is a screenshot of a web page of the open knowledge system represented in FIG. 4 that represents the History tab 543 of the exemplary question content page of FIG. 9;

FIG. 11 is a screenshot of a web page of the open knowledge system represented in FIG. 4 that represents an exemplary version comparison page 550;

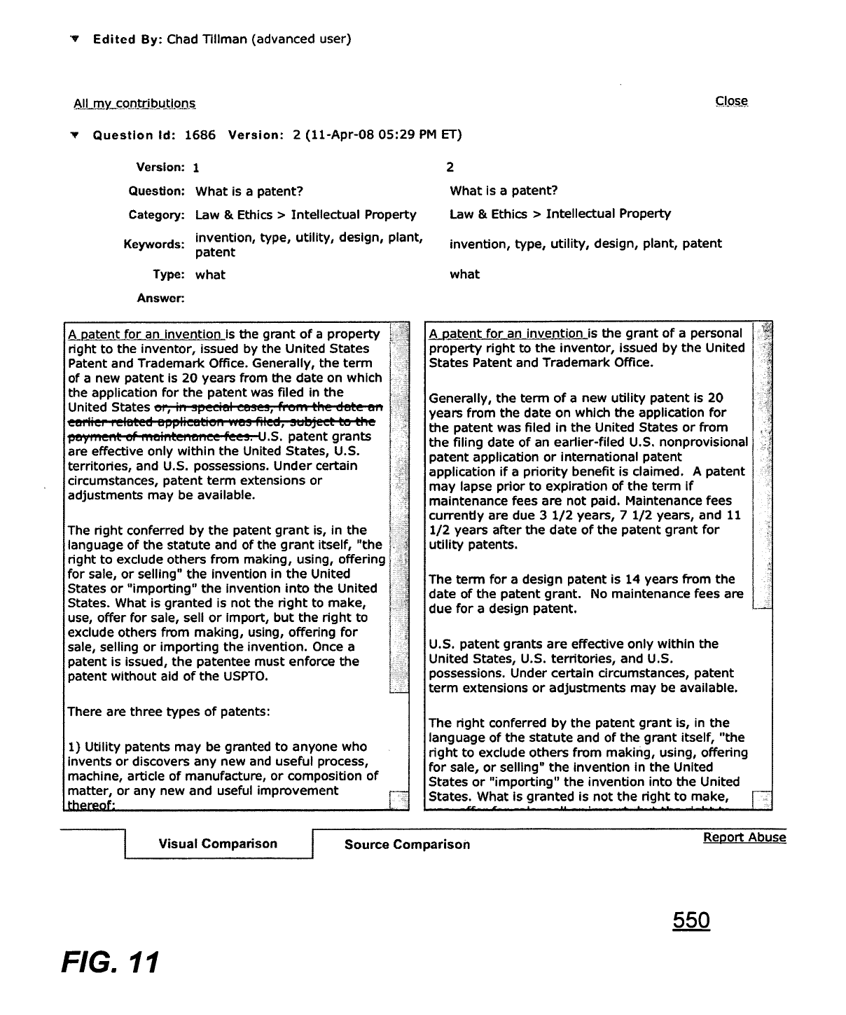

FIG. 12 is a screenshot of a web page of the open knowledge system represented in FIG. 4 that represents an exemplary browsing page 590;

FIG. 13 is a screenshot of a web page of the open knowledge system represented in FIG. 4 that represents an exemplary question entry page 560;

FIG. 14 is a screenshot of a web page of the open knowledge system represented in FIG. 4 that represents an exemplary groups page 570;

FIG. 15 is a screenshot of the groups page 570 of FIG. 14 that demonstrates the effect of clicking on a category;

FIG. 16 is a screenshot of the groups page 570 of FIG. 14 that demonstrates use of a group menu 571;

FIG. 17 is a screenshot of the groups page 570 of FIG. 14 that demonstrates navigation from a groups page 570 to a question content page 540;

FIG. 18 is a screenshot of a question content page 540;

FIG. 19 is a screenshot of a web page of the open knowledge system represented in FIG. 4 that represents an exemplary recent changes page 580;

FIG. 20 is a screenshot of a web page of the open knowledge system represented in FIG. 4 that represents an exemplary Frequently Asked Questions (“FAQ”) page 581;

FIG. 21 displays a search FAQ which can be navigated to via a menu on the web page of FIG. 20 by clicking on an entry labeled “Search Question”;

FIG. 22 displays a viewing FAQ, which can be navigated to via a menu on the web page of FIG. 20 by clicking on an entry labeled “View Question”;

FIG. 23 displays an editing FAQ, which can be navigated to via a menu on the web page of FIG. 20 by clicking on an entry labeled “Ask/Edit Question”;

FIG. 24 displays a membership FAQ which can be navigated to via a menu on the web page of FIG. 20 by clicking on an entry “Membership Registration”;

FIG. 25 displays a preferences FAQ, which can be navigated to via a menu on the web page of FIG. 20 by clicking on an entry labeled “Manage My Preferences”;

FIG. 26 displays a community FAQ which can be navigated to via a menu on the web page of FIG. 20 by clicking on an entry labeled “Community”;

FIG. 27 displays a problem FAQ which can be navigated to via a menu on the web page of FIG. 20 by clicking on an entry labeled “Report a Problem”;

FIG. 28 is a screenshot of a web page of the open knowledge system represented in FIG. 4 that represents an exemplary editing page 110;

FIG. 29 is a screenshot of the web page of FIG. 28 demonstrating a “type” dropdown menu;

FIG. 30 is a screenshot of the web page of FIG. 28 demonstrating a “category” expandable menu;

FIG. 31 is a diagram demonstrating possible paths of user interaction with of the open knowledge system represented in FIG. 4;

FIG. 32 is a is a flowchart of a method of searching the open knowledge system represented in FIG. 4; and

FIG. 33 is a is a screenshot of a web page showing results of a search of the open knowledge system represented in FIG. 4.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

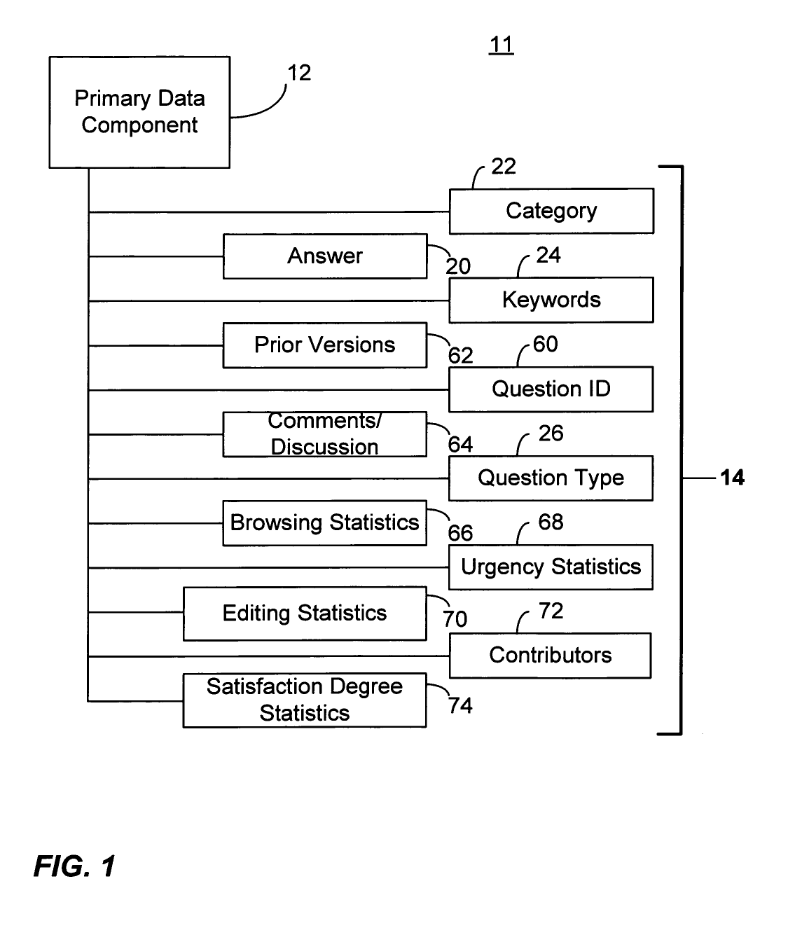

FIG. 1 is a block diagram of a data structure 11 stored in computer-readable medium for use in an open knowledge system in accordance with a preferred embodiment of the present invention. As shown therein, the data structure 11 includes a primary data component 12, and a plurality of secondary data components 14. Both the primary data component 12 and at least one secondary data component 14 are designed to be editable by a user in the open knowledge system.

The primary data component 12 is configured to store primary data representing a particular topic. The particular topic represented by the primary data may be presented to users in the form of a question. For example, the primary data component 12 of a record utilizing the data structure 11 might store data representing the particular topic of a patent, and the particular topic may be presented to users in the format of, “What is a patent?”

The secondary data components 14 of the data structure 11 include:

a) An informational content component 20;

b) A category component 22;

c) A keywords component 24;

d) An ID component 60;

e) A prior version component 62;

f) A user comments and discussion component 64;

g) A question type component 26;

h) A browsing statistics component 66;

i) An urgency statistics component 68;

j) An editing statistics component 70;

k) A contributors component 72; and

l) A satisfaction degree statistics component 74.

The informational content component 20 is configured to store informational content pertaining to the particular topic represented by the primary data stored in the primary data component 12. The informational content may be presented to users in the form of an answer, especially when the particular topic is presented in the form of a question. For example, if the primary data represents the question “What does the Earth orbit?”, the informational content may represent the answer “The Sun.”

The category component 22 is configured to store data representing a category of the particular topic. In this way, the questions in the open knowledge system may be classified into categories. Additionally, a broad category can be divided up into may sub-categories. For example, a question asking how to protect your skin from the sun could be placed in the sub-category “Health>Health care>Skin protection”.

The keywords component 24 is configured to store metadata representing a plurality of descriptors. The descriptors pertain to the particular topic and the informational content. Specifically, the descriptors may include keywords of the question and keywords of the answer. For example, a question asking “What does the Earth orbit?” may be described by the keywords “Astronomy, Science, Sun, Earth”.

In at least one embodiment, the keywords component 24 may include not just keywords, but also may include a particular weight assigned to each keyword. For example, the question “What does the Earth orbit?” may be described by the same keywords as set forth above, but each keyword may not be given equal weight. Instead, each keyword may be given a relative weight, such that the combined relative weight of all keywords adds up to a total of 100%, or 1. The question, “What does the Earth orbit?” may have a first keyword “Astronomy”, weighted at 20%, a second keyword “Science”, weighted at 10%, a third keyword “Sun”, weighted at 50%, and a fourth keyword “Earth”, weighted at 20%. Another question, “What is the Sun?” may have two keywords, a first keyword “Sun”, weighted at 80%, and a second keyword “Science”, weighted at 20%. Searching for “Sun” would cause the question “What is the Sun?” to be returned before the question “What does the Earth orbit?” because the “Sun” keyword is given more weight in the “What is the Sun?” question.

The ID component 60 is configured to store a unique database identification number that is logically associated with a unique record utilizing the data structure 11. In this respect, each question preferably is associated with a record that utilizes data structure 11 and, thus, is associated with a unique identification number, which identification number can be used to search for and view questions in the knowledge system. This identification number, however, is mainly intended to be used by system programs, although users 80 can utilize the identification number as well. Specifically, a user 80 who knows the identification number corresponding to a certain record may search the database for the record corresponding to that identification number.

The prior version component 62 is configured to store data of the data structure 11 for a record that was previously stored but has since been modified or deleted. Such data may represent informational content that was previously stored in the informational content component 20 but has since been modified or deleted, or may represent a particular topic that was previously stored in the primary data component 12 but has since been modified or deleted. For example, a user 80 who is not satisfied with the current answer may wish to view past versions of the answer to determine if a past version satisfies him more completely than the current one.

The user comments and discussion component 64 is configured to store comments and discussion threads posted by users that relate to informational content or a particular topic of a record utilizing the data structure 11. This may be useful when an answer is disputed and discussion is ongoing as to what may or may not be the correct answer. Users 80 may post their thoughts as comments or as part of a discussion without actually editing the existing answer.

The question type component 26 is configured to store data representing the type of question that is presented to users that represents the particular topic of a record utilizing the data structure 11. Knowing what type of question a particular topic presents can be useful in searching the database, as a user 80 may wish to learn the location of something and hence may only desire to search “Where” questions.

The contributors component 72 is configured to store data representing an identification of each user who has modified the data of a record. This may be useful for a variety of reasons. It may be useful to identify a particular user 80 whose answers are particularly insightful or informative. Alternatively it may be useful to identify a user 80 who is providing answers that are not useful and that negatively impact the knowledge system as a whole.

The browsing statistics component 66 is configured to store data representing browsing statistics of the informational content of a record utilizing the data structure 11. This may be useful to administrators to keep track of which questions are receiving the most attention. It may also be useful to users 80 who may then seek to answer questions in the areas that seem the most heavily trafficked.

The urgency statistics component 68 is configured to store data representing urgency statistics relating to a record utilizing the data structure 11. This may be useful for users 80 to identify which questions they should prioritize answering.

The satisfaction degree statistics component 74 is configured to store data representing degree-of-user-satisfaction statistics relating to the informational content of a record utilizing the data structure 11. A user 80 who reads a particular answer to a question may have no idea whether the answer represents a good answer or not. Satisfaction degree statistics may be useful to help a user 80 determine how much trust should be placed in a particular answer by seeing how satisfied other (potentially more informed) users 80 were with the particular answer.

The editing statistics component 70 is configured to store data representing editing statistics. The editing statistics may represent how often the content of a certain record is edited. This may be useful to a user 80, as an answer that is edited every day may not be as reliable as an answer that has not been edited in months.

The plurality of secondary data components 14 illustrated in FIG. 1 and described in detail above are not meant to be an exhaustive list of all possible attributes. In the preferred embodiment illustrated in FIG. 1, certain other secondary data components not therein illustrated may still be included. Likewise, in other embodiments, one or more of the secondary data components 14 illustrated in FIG. 1 may be omitted.

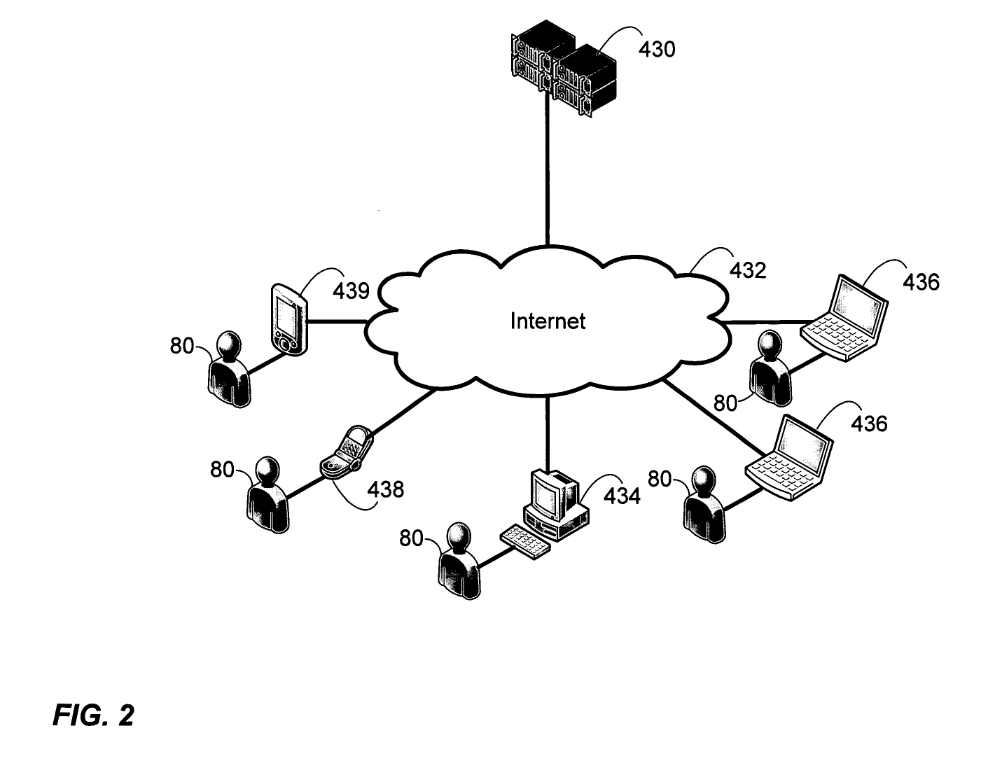

A schematic view of the architecture of a preferred embodiment of the present invention is shown in FIG. 2. The architecture includes a server 430 connected to the Internet 432 that runs computer executable instructions for providing the open knowledge system of the preferred embodiment of the present invention. The server 430 furthermore may include on or more computers. Indeed, the functioning of the open knowledge system may be distributed over several different computers including a server computer and a database computer. Server 430 is intended to broadly represent any such arrangement. The open knowledge system is accessible by a plurality of users 80 through, for example, a desktop computer 434 connected to the Internet 432; through laptop computers 436 connected to the Internet 432; through a web-enabled phone 438 connected to the Internet 432; and through a web-enabled PDA 439 connected to the Internet 432.

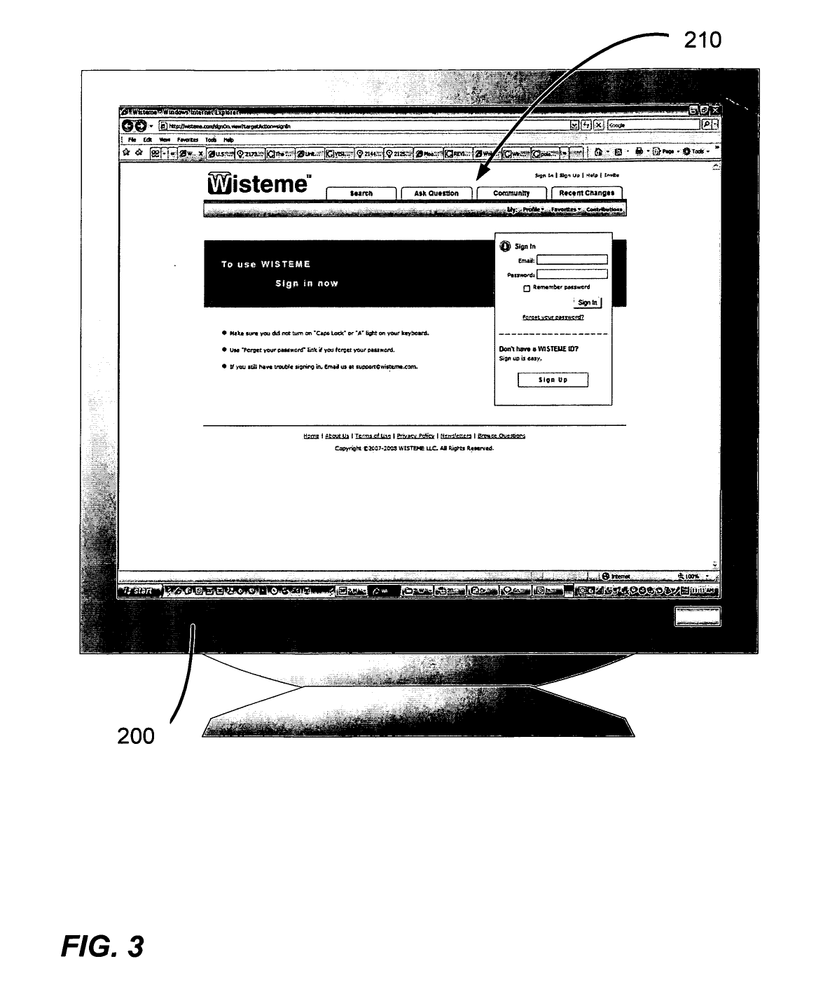

FIG. 3 is an illustration of a computer monitor 200 displaying a log-in web page 210 for members of the open knowledge system of a preferred embodiment of the present invention.

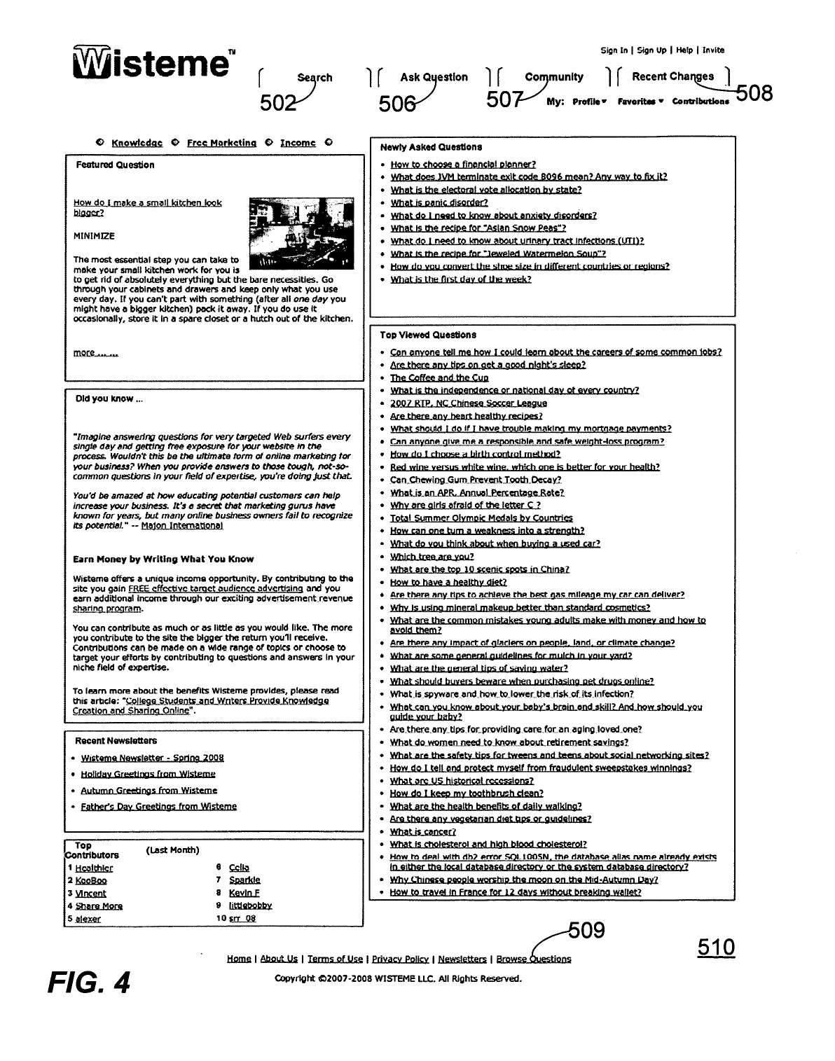

FIG. 4 is a screenshot of a home page of the open knowledge system of a preferred embodiment of the present invention. At the top of the home page are four links for navigation to different web pages of the preferred embodiment. These links include a Search link 502, an Ask Question link 506, a Community link 507, and a Recent Changes link 508. At the bottom of the page is a Browse Questions link 509.

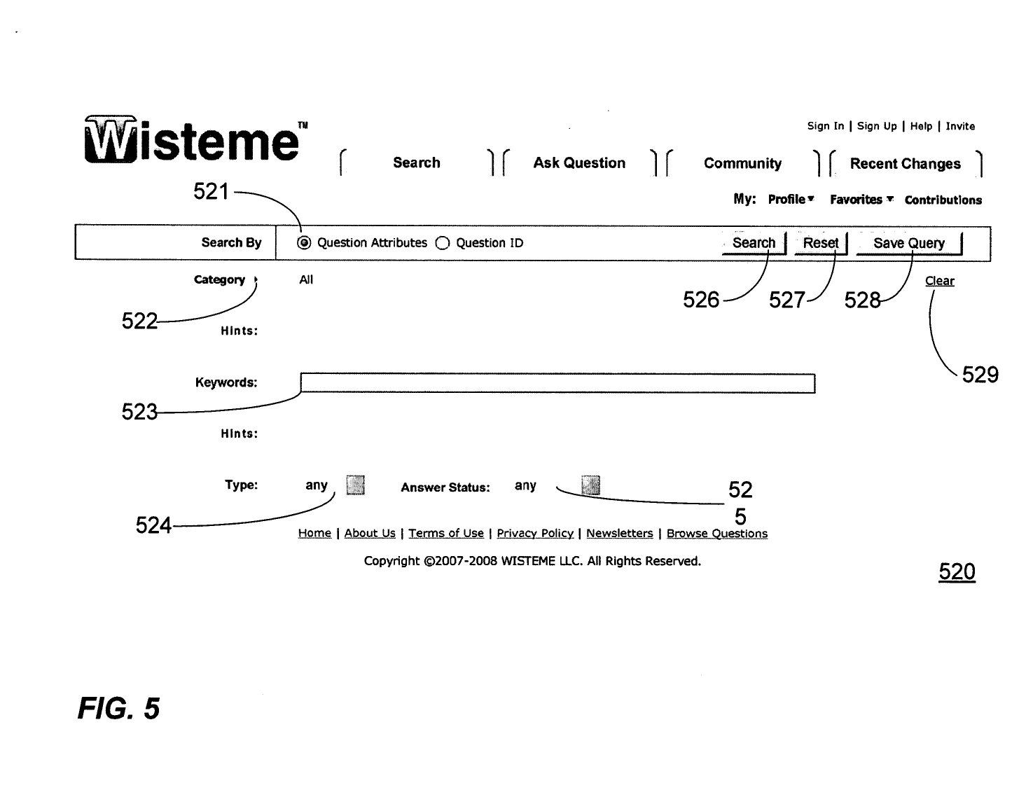

Clicking on the Search link 502 effects navigation to the Search page 520. FIG. 5 is a screenshot of a web page of the open knowledge system represented in FIG. 4 that represents an exemplary Search page 520. The Search page 520 includes a group of search selection radio buttons. In FIG. 5 a Question Attribute radio button 521 is selected, indicating that a search will be performed based upon a question's attributes, rather than upon a unique ID number.

A first attribute that may be inputted via the Search page 520 is a category. Mousing over a Category expandable menu 522 allows selection of a category to be used in searching. A search will preferably return only those results associated with the selected category. A second attribute that may be inputted via the Search page 520 is a collection of keywords. One or more keywords may be entered into a Keywords edit field 523. A search will preferably return only those results associated with the keywords inputted. A third attribute that may be inputted via the Search page 520 is a question type. A Type dropdown menu 524 allows selection of a question type to search for. A search will preferably return only those results that match the question type selected. A fourth attribute that may be inputted via the Search page 520 is an answer status indicator. An Answer Status dropdown menu 525 allows for the selection of a specific answer status. The answer status of a question indicates whether that question has been answered. A search will preferably return only those results that match the answer status selected.

The Search page 520 also includes a Search button 526, a Reset button 527, a Save Query button 528, and a Clear button 529. The Save Query button 528, when pressed, will save the selections and text entered into the Category expandable menu 522, the Keywords edit field 523, the Type dropdown menu 524, and the Answer Status dropdown menu 525. The Reset button 527, when pressed, will clear the selections and text entered into the Category expandable menu 522, the Keywords edit field 523, the Type dropdown menu 524, and the Answer Status dropdown menu 525. The Clear button 529, when pressed, will reset the currently selected category to “All”, indicating that all categories will be searched. The Search button 526, when pressed, will effect a search using the selections and text entered into the Category expandable menu 522, the Keywords edit field 523, the Type dropdown menu 524, and the Answer Status dropdown menu 525.

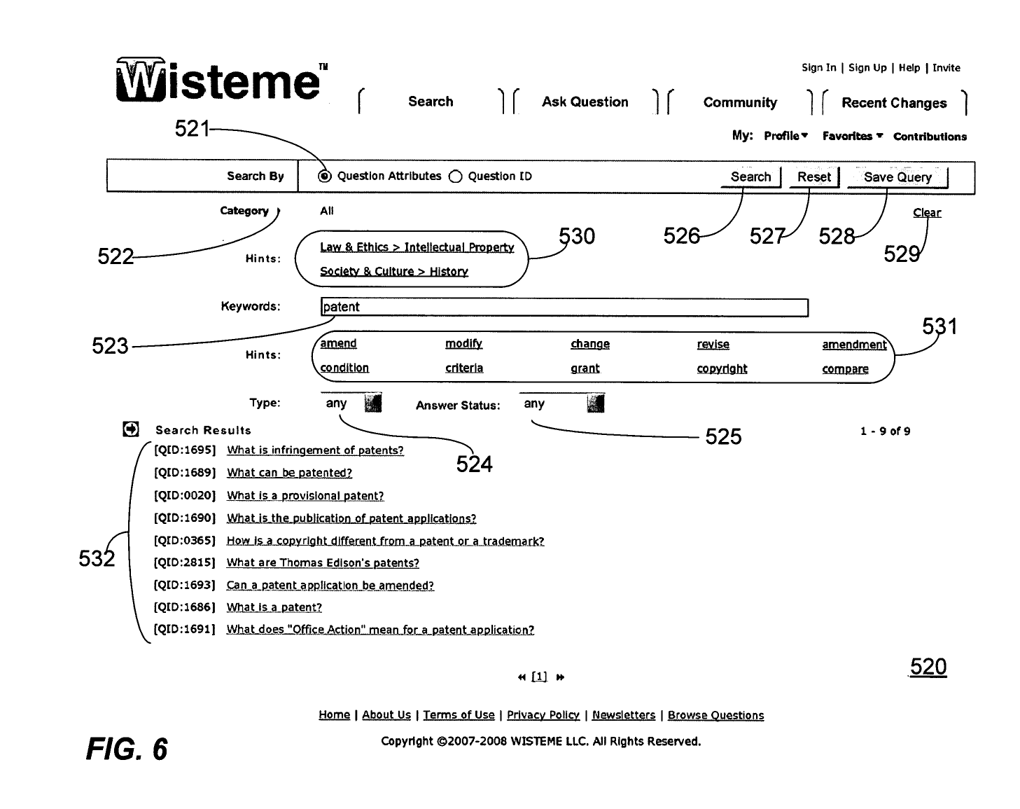

For example, if one were to type “patent” into the Keywords edit field 523, and then click the Search button 526, a search would be effected and results would appear, as can be seen in FIG. 6. Search Results 532 are displayed on the bottom of the Search page 520. Each search result is a link to a question that matches the category, keywords, question type, and answer status searched for. In addition to the Search Results 532, the page also displays hints that may be useful in further refining the prior search. In FIG. 6, the text “patent” was searched for in all categories and all question types with any answer status. In response to this search, the Search page 520 displays Category Hints 530 that suggest potential categories that may be selected to further narrow the search. Additionally, the Search page 520 displays Keyword Hints 531 that may be selected to further narrow the search.

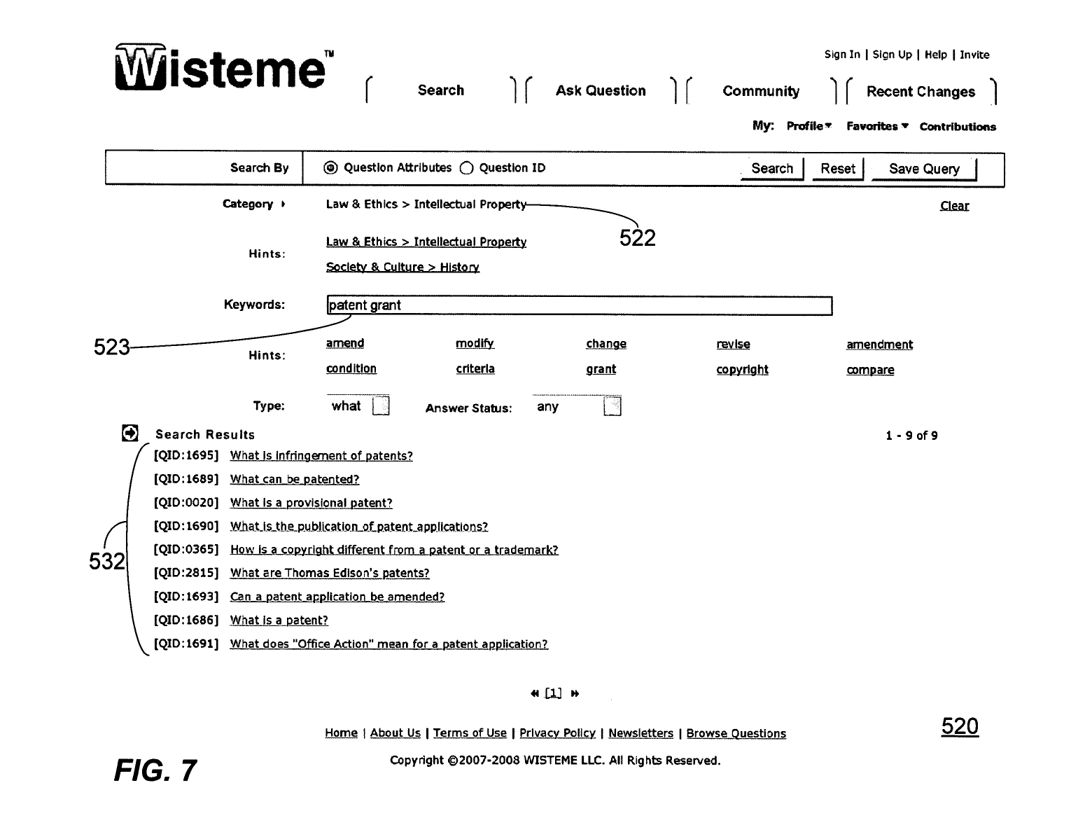

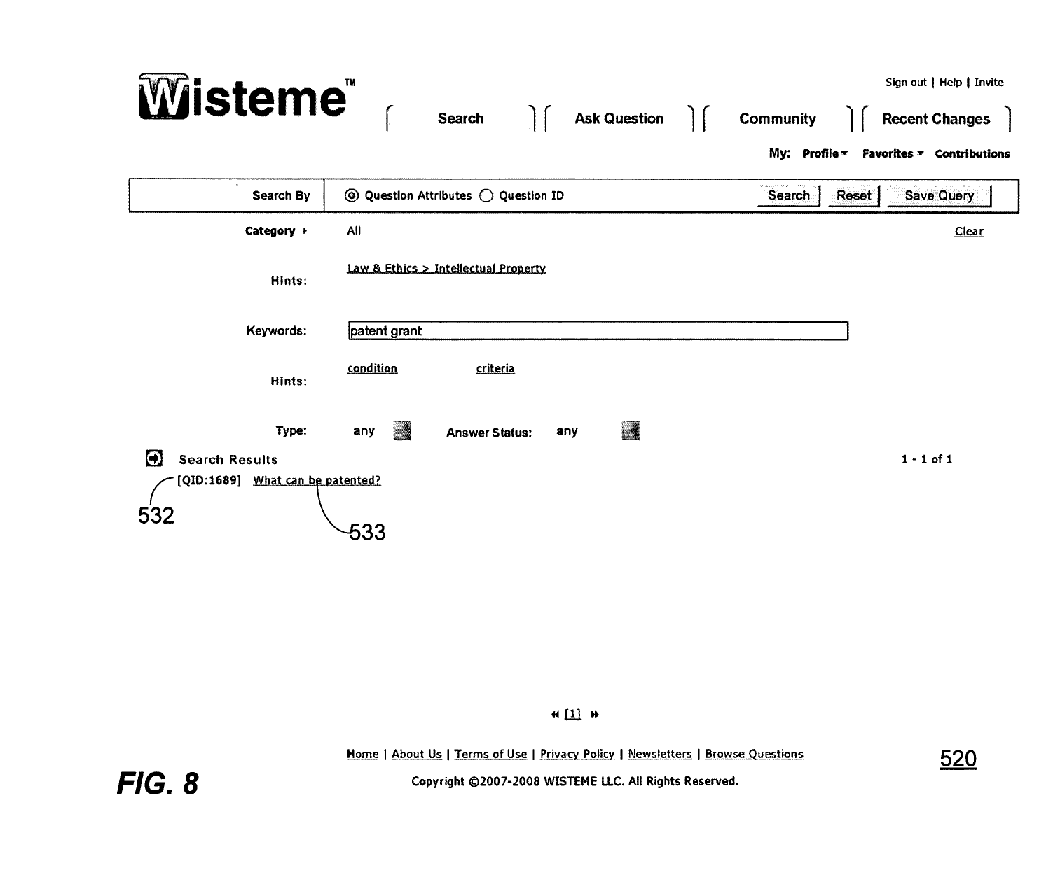

Clicking on one of the displayed Category Hints 530 will cause the category selected in the Category expandable menu 522 to change to the category clicked on. Clicking on one of the displayed Keyword Hints 531 will add the keyword to the Keywords edit field 523. FIG. 7 demonstrates how the Search page 520 of FIG. 6 would appear after clicking on the displayed Category Hint 530 “Law and Ethics>Intellectual Property” and the displayed Keyword Hint 531 “grant”. As can be seen in FIG. 7, the Category expandable menu 522 is changed to select “Law and Ethics>Intellectual Property” and the word “grant” is added to the Keywords edit field 523. A second search may then be effected with these refined parameters. In FIG. 8 it can be seen that the Search Result 532 of this second search is a single result. This demonstrates how Category Hints 530 and Keyword Hints 531 may be utilized to narrow down a search that returned many Search Results 532 to just one Search Result 532.

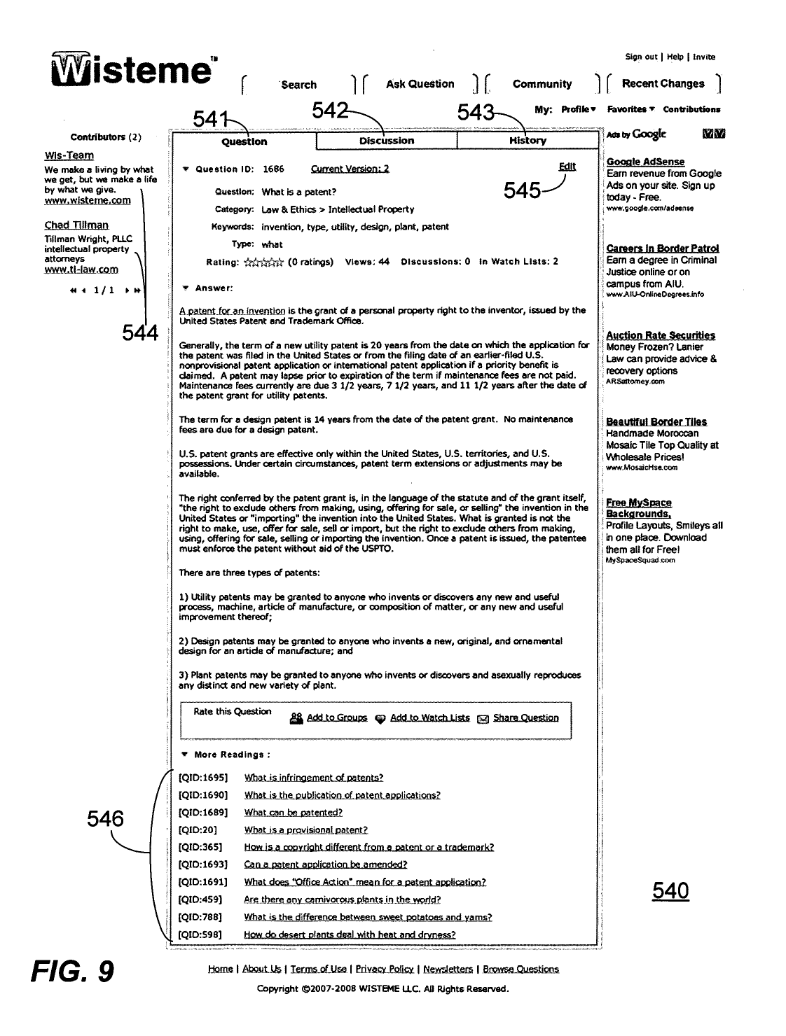

Clicking on the result link 533 of the Search Result 532 takes you to a question content page 540. FIG. 9 is a screenshot of a web page of the open knowledge system represented in FIG. 4 that represents an exemplary question content page 540. The question content page 540 has three tabs at the top of the page: a Question tab 541, a Discussion tab 542, and a History tab 543. No matter which tab is open, a list of contributors 544 will appear on the left side of the page detailing those that have made a contribution to the question content page 540. Each contributor will have a short message of his choice displayed under his name, along with a website link.

In FIG. 9, the exemplary question content page 540 is open to the Question tab 541, which displays at the very top a question ID number, a current version number of the information displayed on the question content page 540, and an edit button 545. Below this is a question, a category the question is categorized into, keywords associated with the question, and a type that the question is considered to be. Below these, the Question tab 541 displays a rating that has been determined by user input, the number of times the question content page 540 for the question has been viewed, the number of discussions that are on-going concerning the question, and the number of users who have placed the question in their watch list. Below this information is an answer to the question. Further, below the answer, are links that will add the question to your groups (as described hereinafter below), add the question to a watch list, or share the question with someone via email. Still yet, at the bottom of the Question tab 541 is a list of related questions 546.

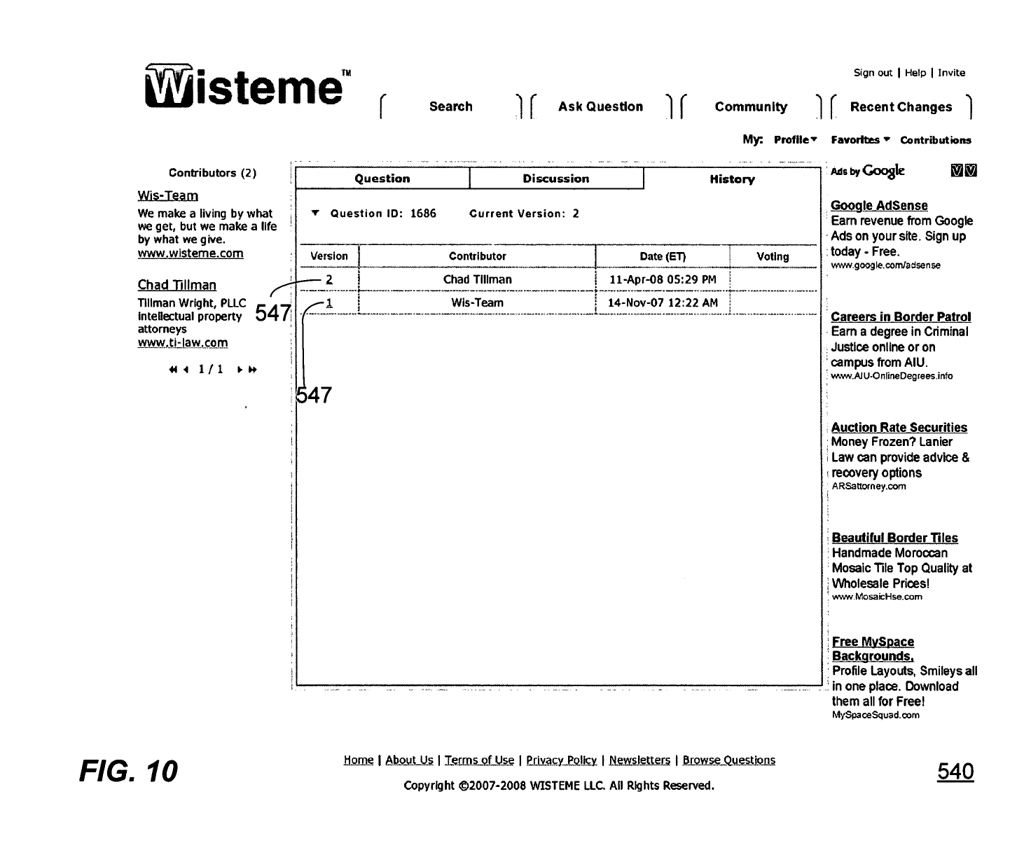

FIG. 10 is a screenshot of a web page of the open knowledge system represented in FIG. 4 that represents the History tab 543 of the exemplary question content page of FIG. 9. The History tab 543 displays the editing history of the content of the question tab 541. Each past version 547 of the content of the question tab 541 may be selected for review.

Clicking on a past version 547 navigates to a version comparison page 550. FIG. It is a screenshot of a web page of the open knowledge system represented in FIG. 4 that represents an exemplary version comparison page 550. The version comparison page 550 provides a comparison of the content of the question tab 541 in the version subsequent to a particular editing with the content of the same question tab 541 in the version prior to the particular editing. Any changes that were made are marked up so as to be clearly visible.

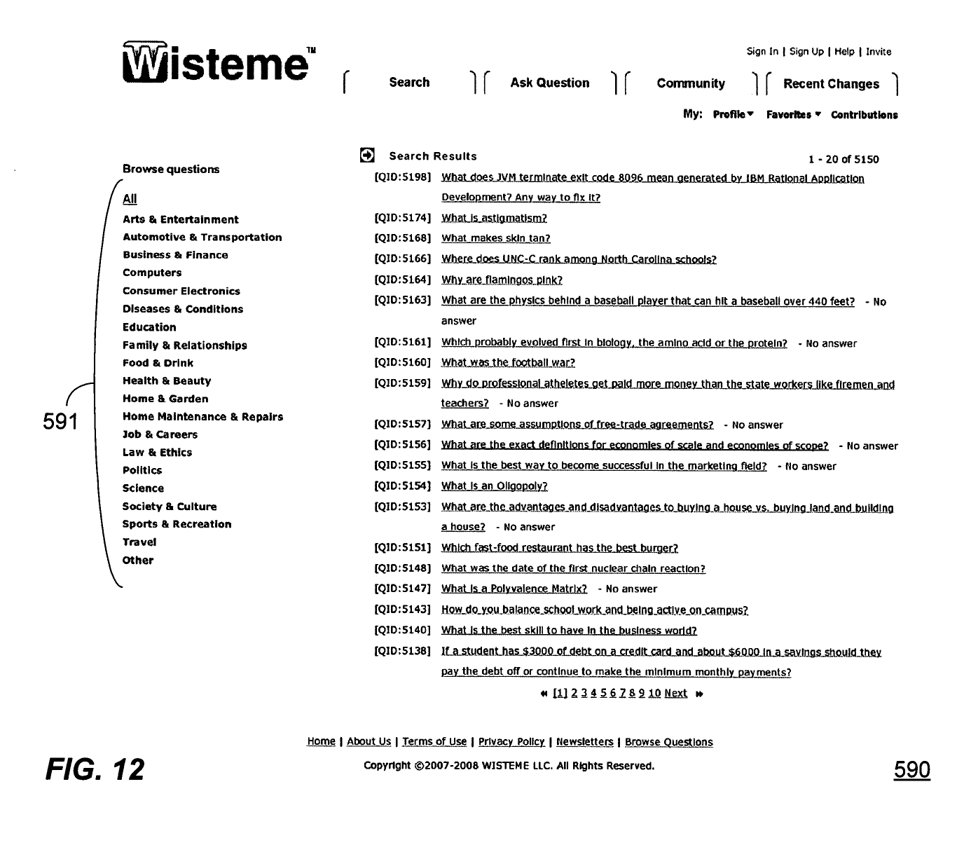

Returning now to the home page of FIG. 4, clicking on the Browse Questions link 509 effects navigation to a browsing page 590. FIG. 12 is a screenshot of a web page of the open knowledge system represented in FIG. 4 that represents an exemplary browsing page 590. The left side of the browsing page 590 presents a list of categories 591 which may be selected for browsing. By default, all categories are selected. The right side of the browsing page 590 presents a list of questions. Selecting a category from the list of categories 591 filters the questions so that only questions belonging to the selected category are displayed. Clicking on a particular question effects navigation to the respective question content page 540 of that question.

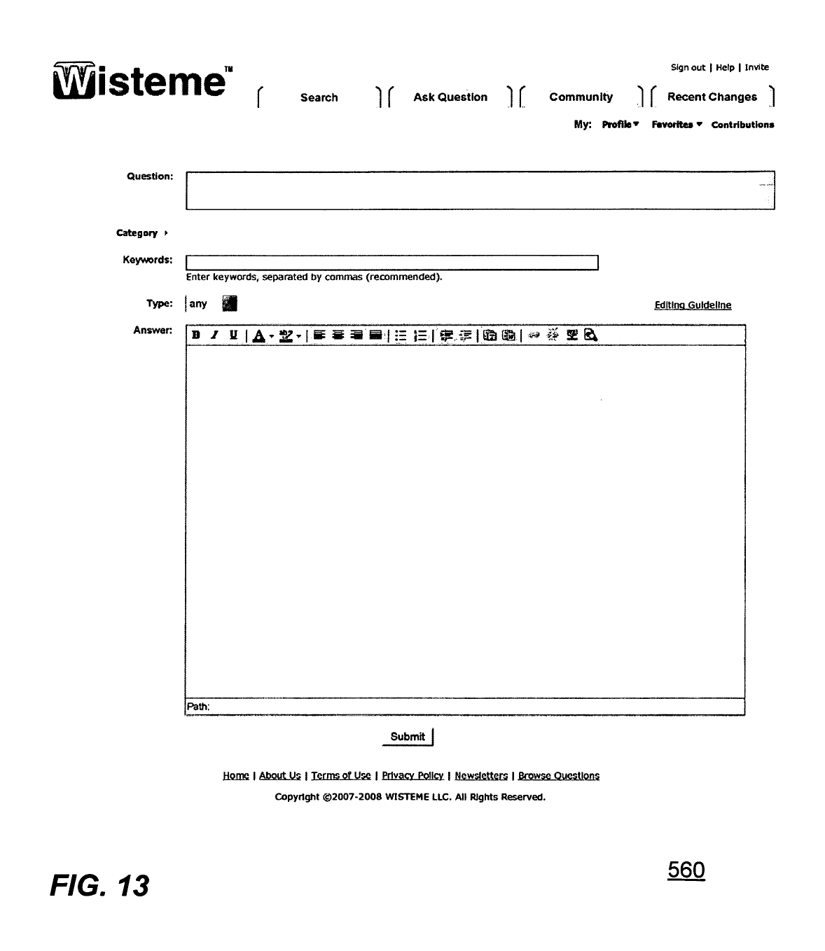

Returning once more to the home page of FIG. 4, clicking on the Ask Question link effects navigation to a question entry page 560. FIG. 13 is a screenshot of a web page of the open knowledge system represented in FIG. 4 that represents an exemplary question entry page 560. The functionality of the question entry page 560 is identical to that of an exemplary editing page 110 described below.

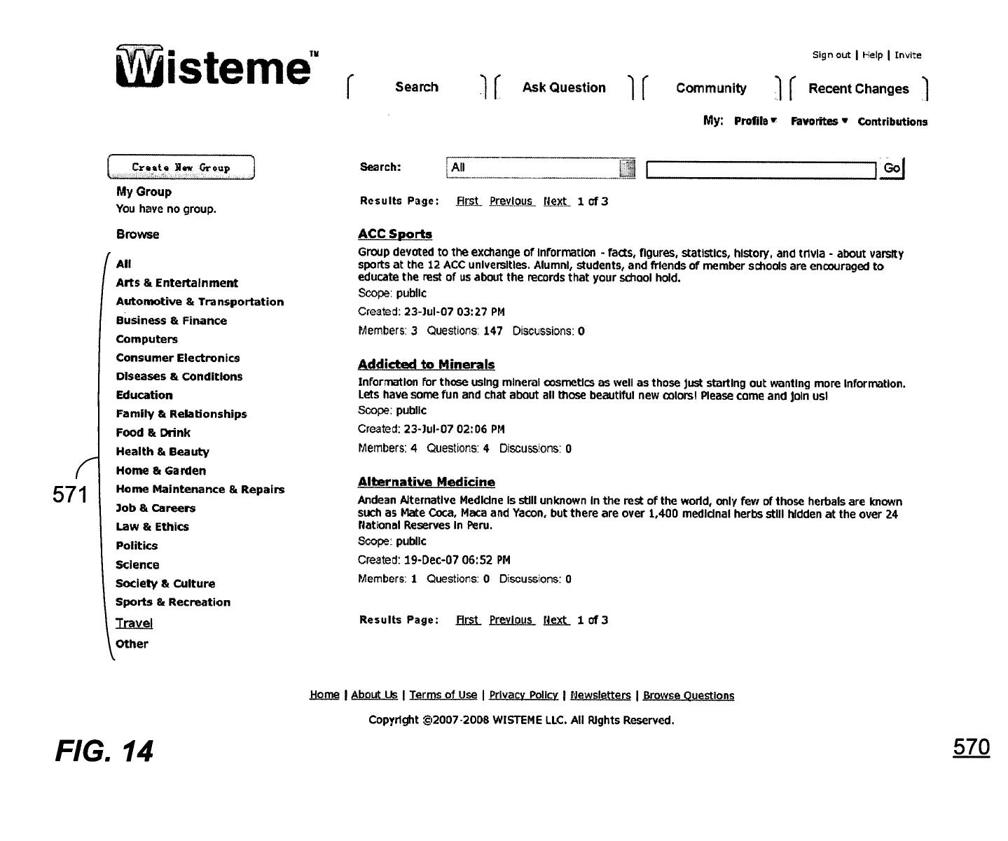

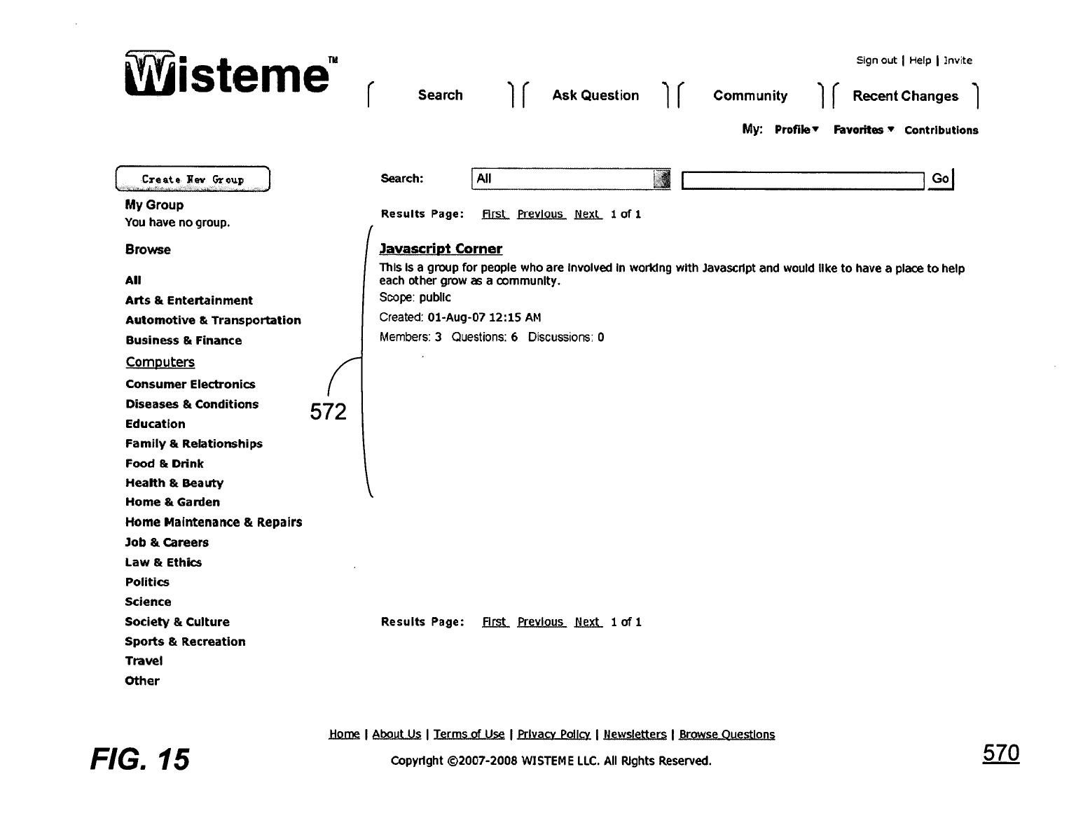

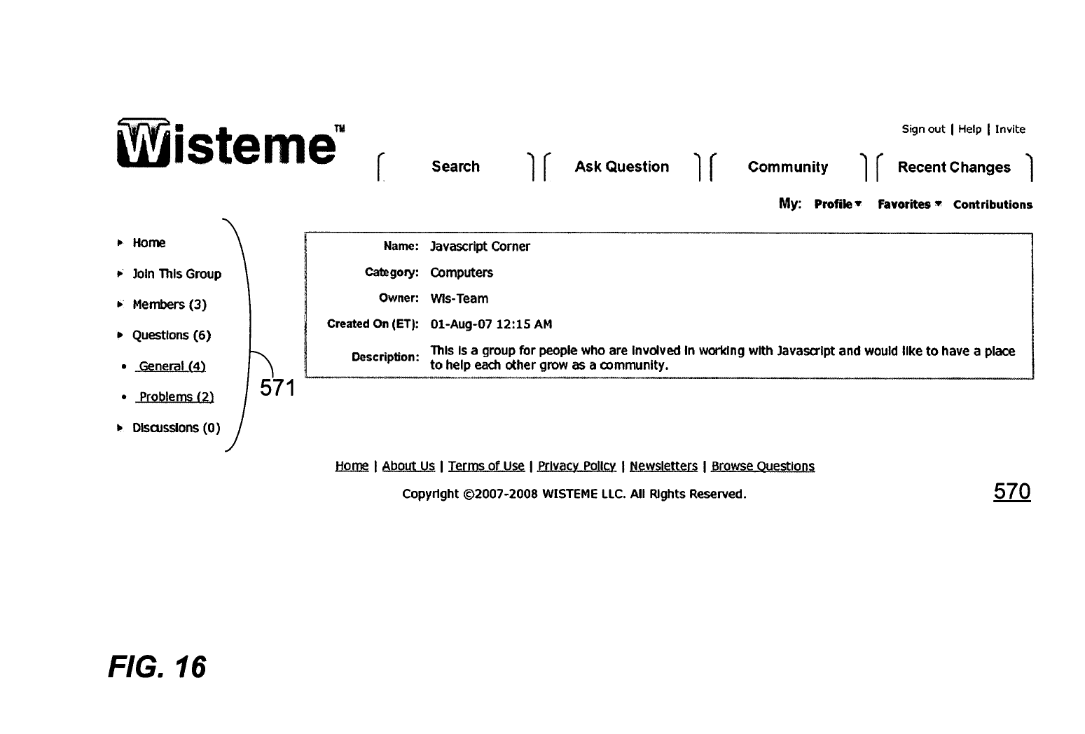

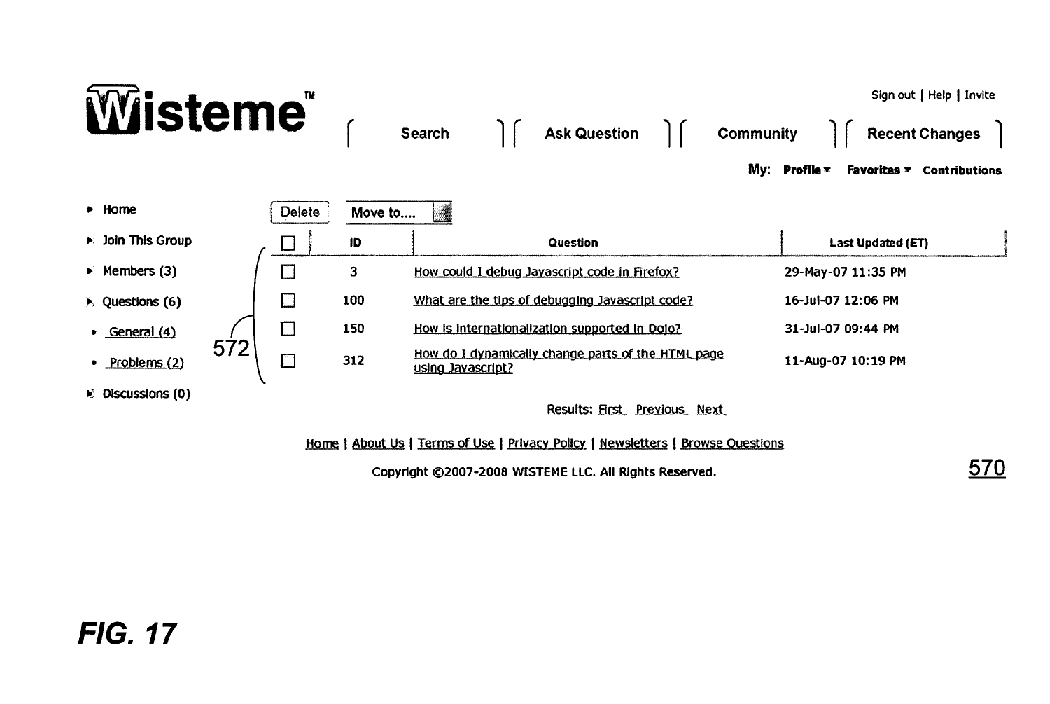

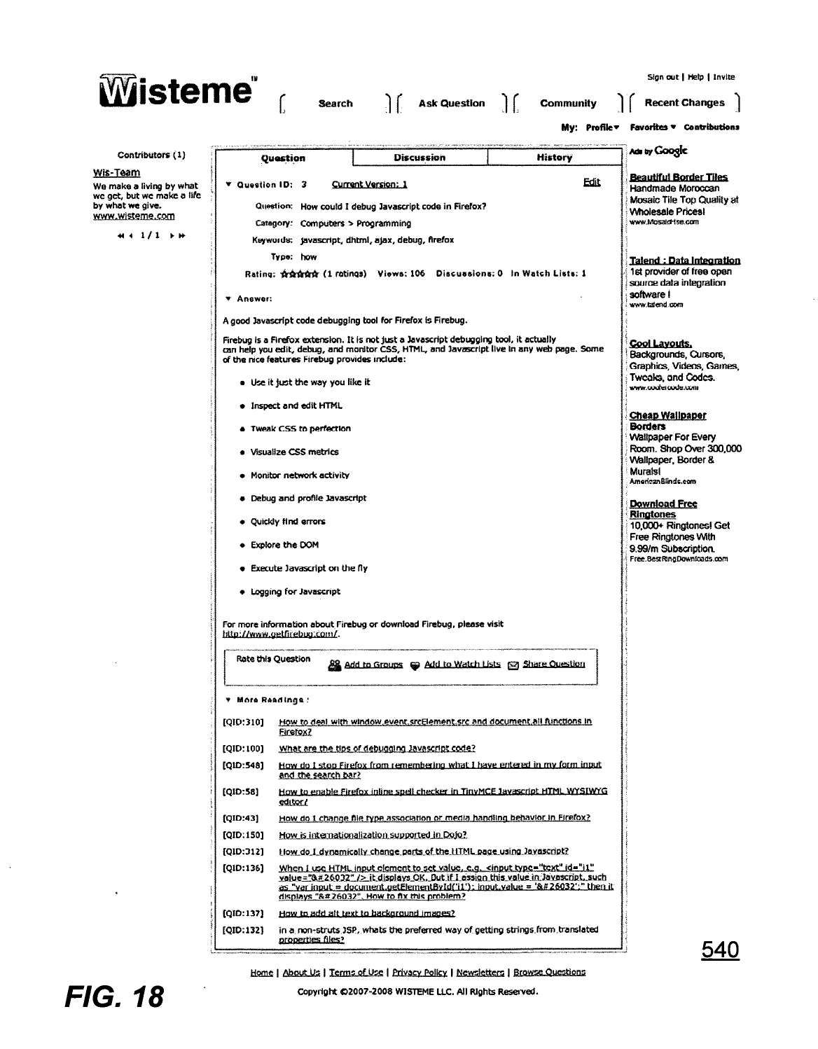

Returning again to the home page of FIG. 4, clicking on the Community link effects navigation to a groups page 570. FIG. 14 is a screenshot of a web page of the open knowledge system represented in FIG. 4 that represents an exemplary groups page 570. On the left side of the groups page 570 is a list of categories that groups may be associated with. FIG. 15 demonstrates the effect of clicking on the “Computers” category. In FIG. 15, a list of groups 572 that are associated with the “Computers” category is displayed on the right side of the screen. In this example, only the group “JavaScript Corner” satisfies that criteria. Clicking on this entry causes information to be displayed specific to that group, as can be seen in FIG. 16. In FIG. 16, information pertinent to this group is displayed on the right side of the screen, and a group menu 571 for navigation within the group is displayed on the left side of the screen. Included in this menu are questions associated with the group. For example, clicking on the menu item in the group menu 571 that is labeled “General”, causes a listing of general questions associated with the group to be displayed, as seen in FIG. 17. In FIG. 17, four questions 572 are displayed on the right side of the screen. Clicking on one of these questions will effect navigation to the respective question content page 540 for that question. For example, clicking on “How could I debug JavaScript code in Firefox?” effects navigation to the question content page 540 that can be seen in FIG. 18.

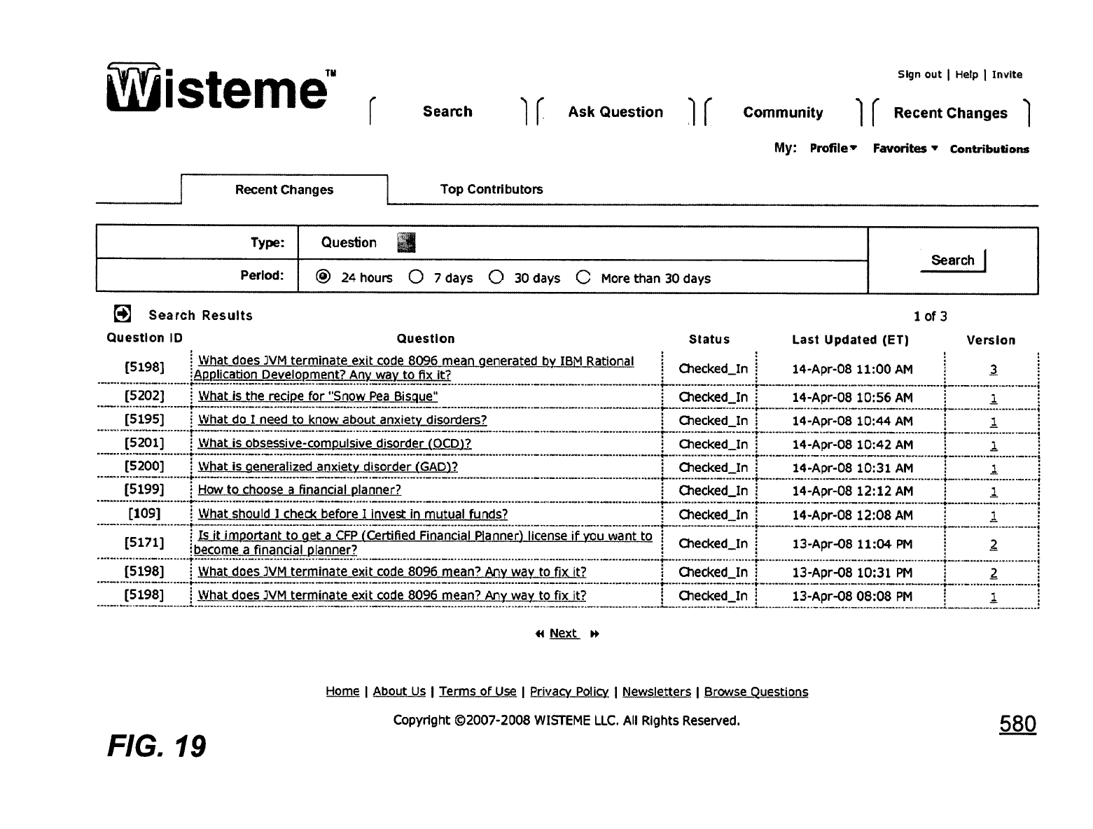

Returning yet again to the home page of FIG. 4, clicking on the Recent Changes link effects navigation to a recent changes page 580. FIG. 19 is a screenshot of a web page of the open knowledge system represented in FIG. 4 that represents an exemplary recent changes page 580. The recent changes page 580 displays the most recent changes that have been made to the content of question content pages 540 Clicking on a particular question will effect navigation to the respective question content page 540.

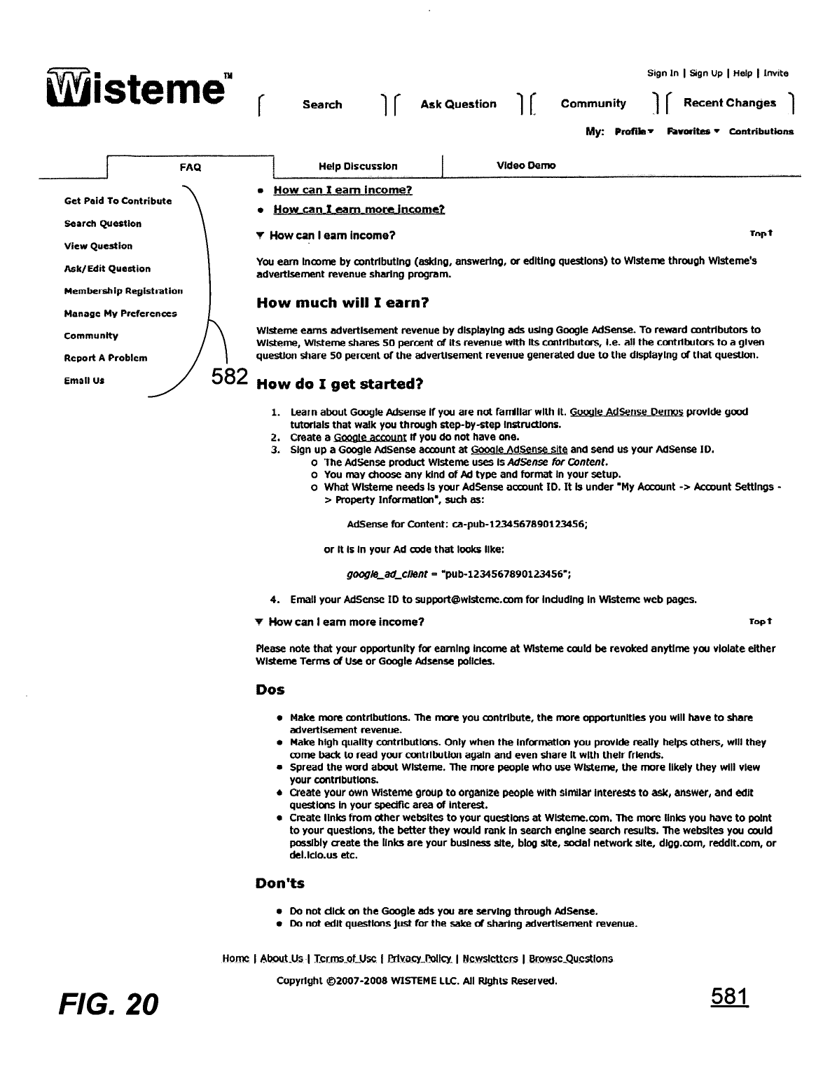

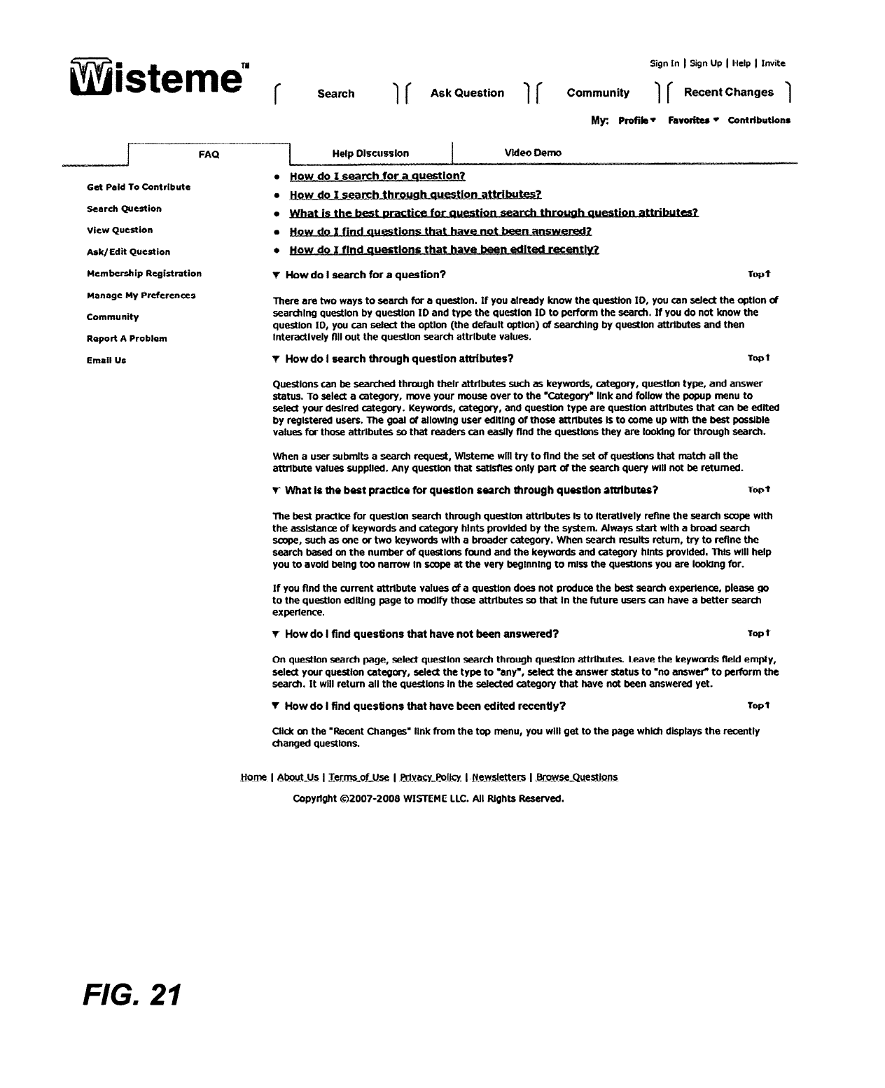

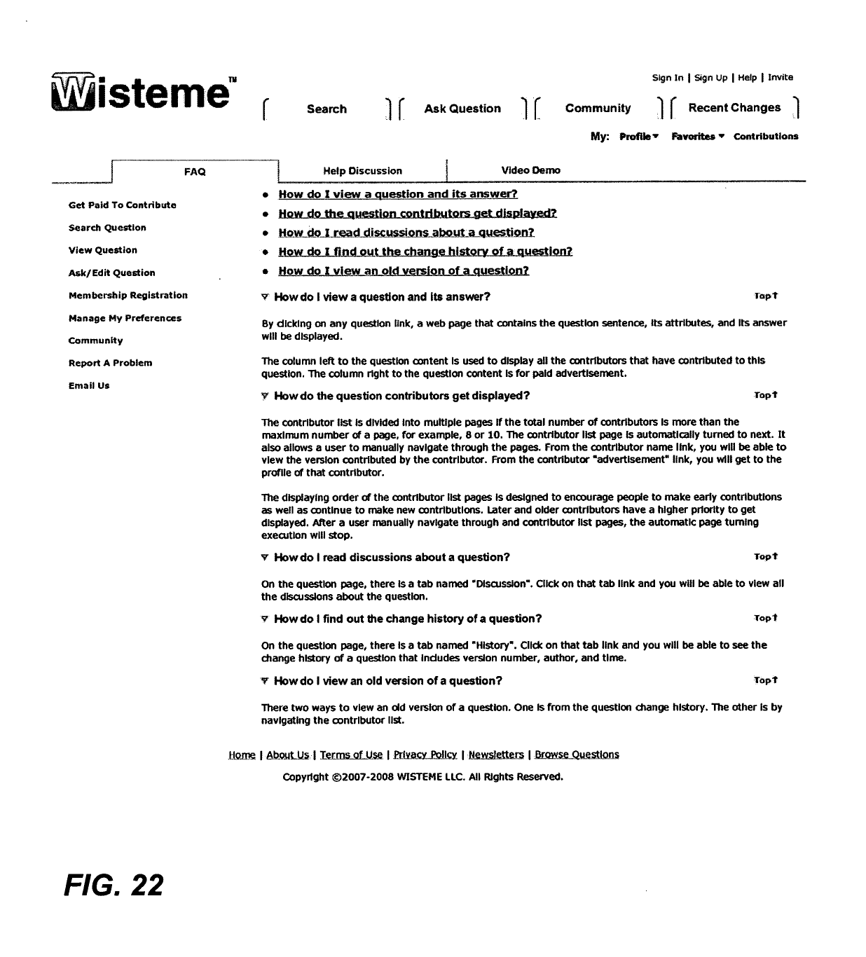

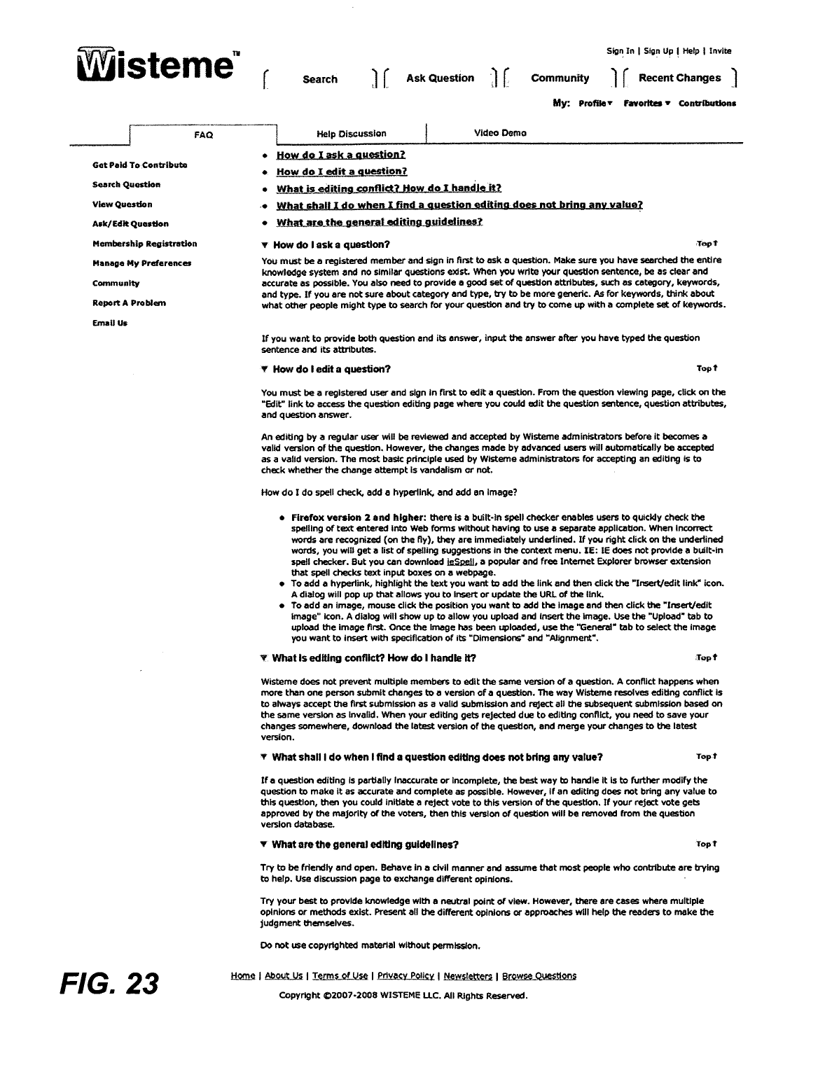

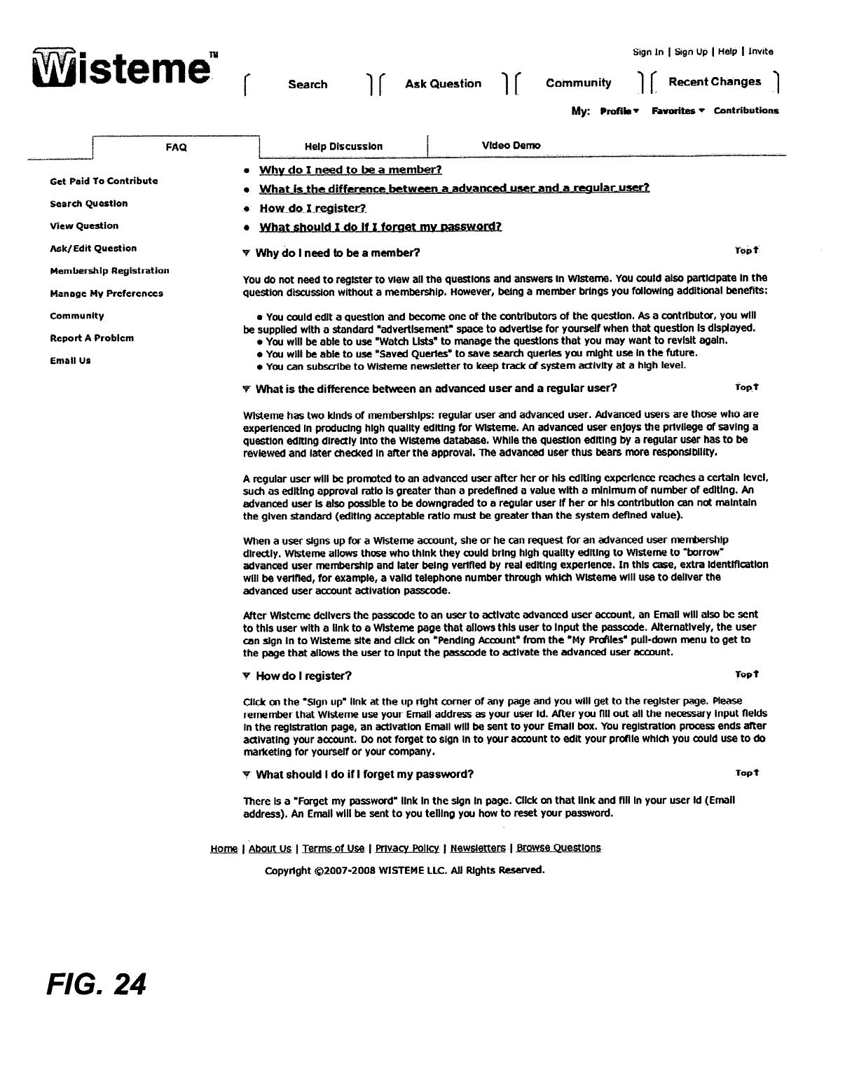

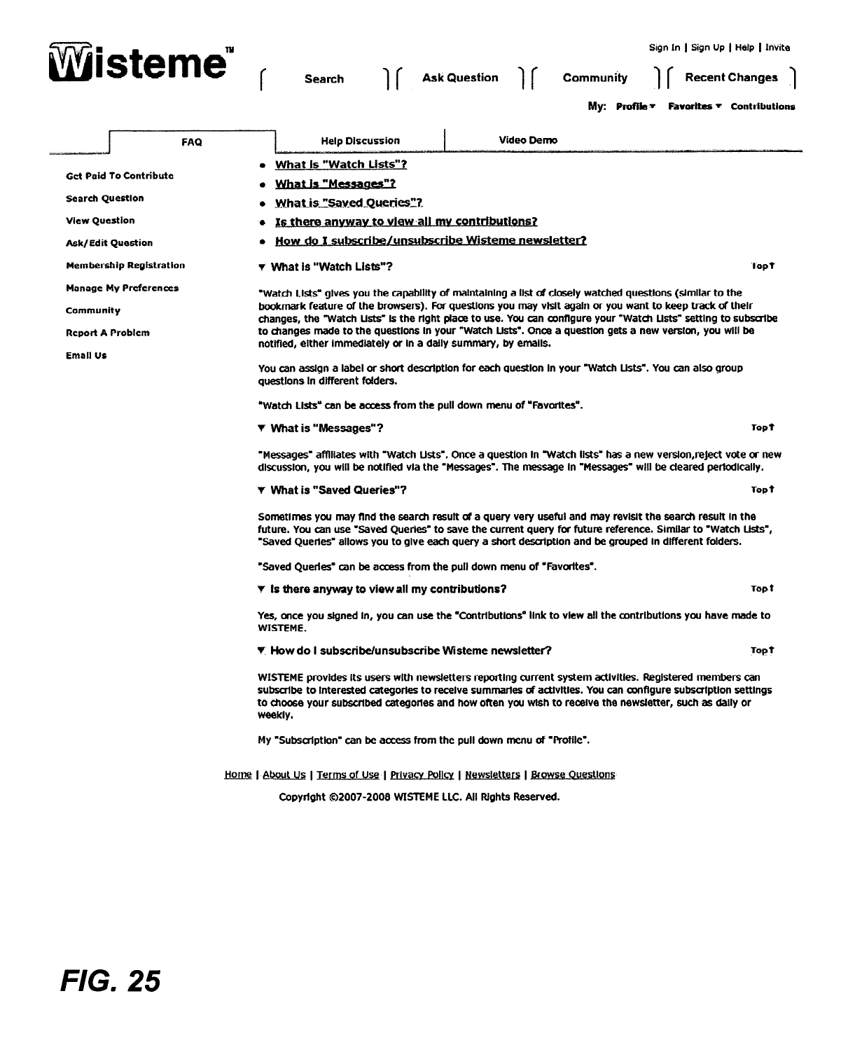

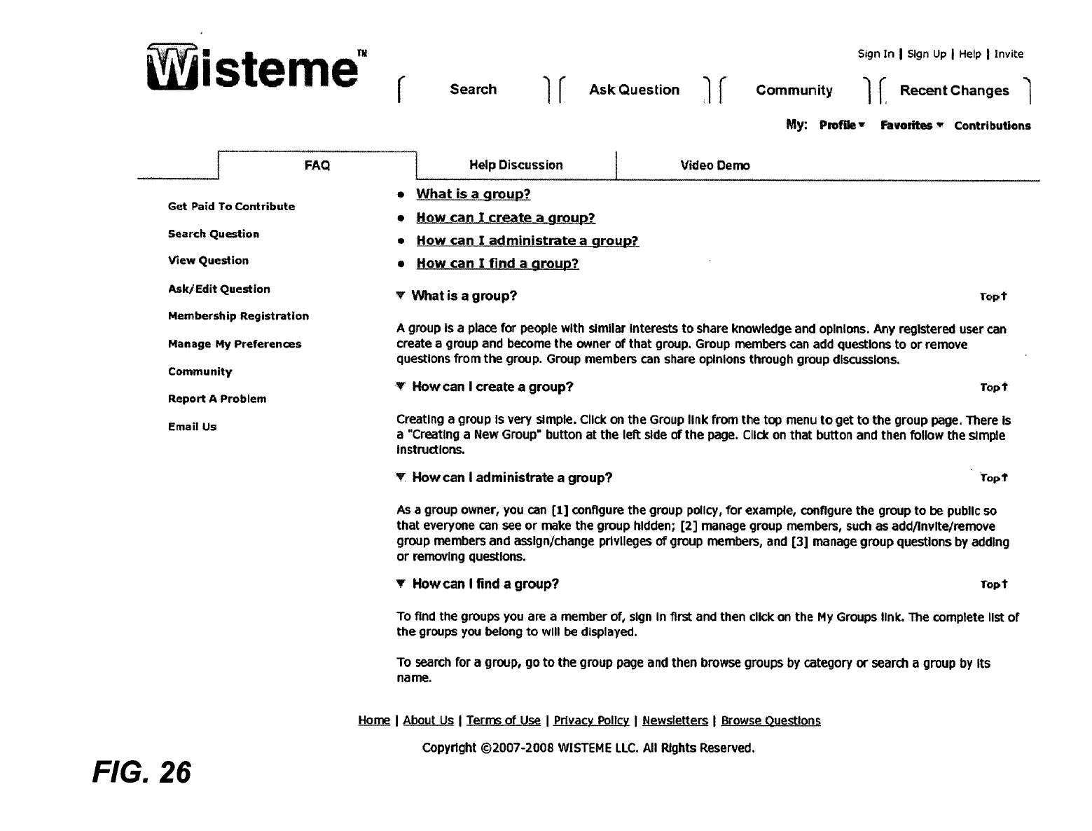

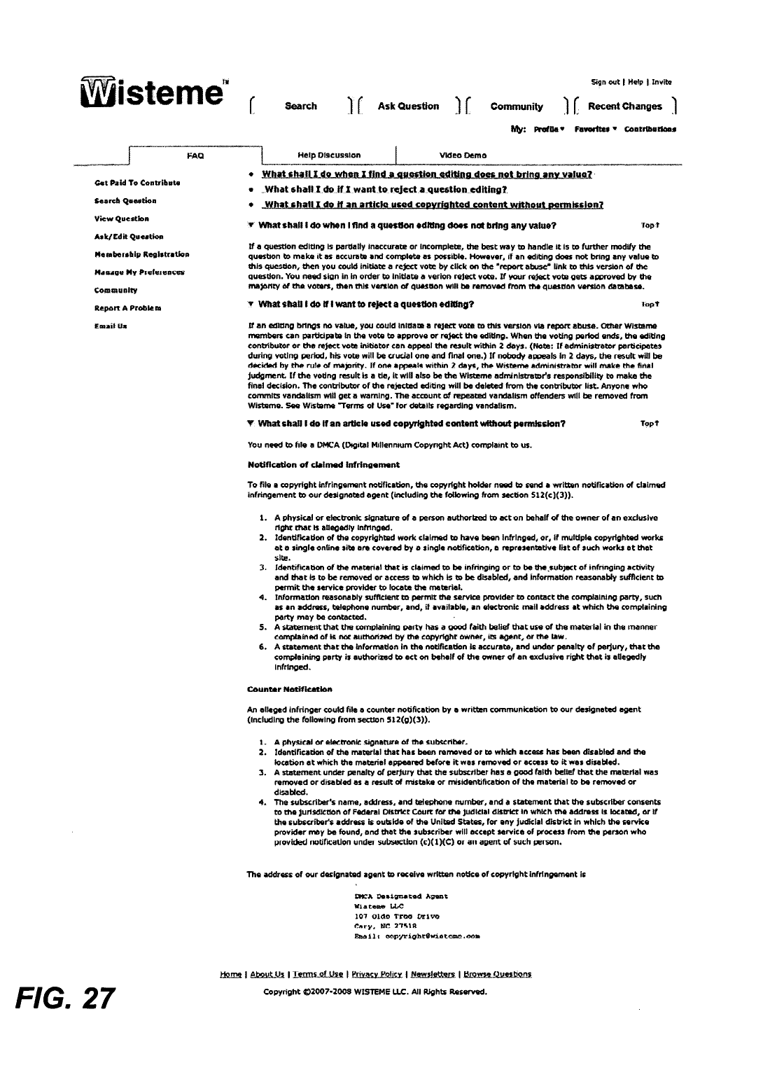

FIG. 20 is a screenshot of a web page of the open knowledge system represented in FIG. 4 that represents an exemplary Frequently Asked Questions (“FAQ”) page 581. The FAQ page 581 includes a FAQ menu 582 that allows for the display of FAQs for varying subjects. FIG. 20 displays an income FAQ which can be navigated to via the menu by clicking on the entry labeled “Get Paid to Contribute”. FIG. 21 displays a search FAQ, which can be navigated to via the menu by clicking on the entry labeled “Search Question”. FIG. 22 displays a viewing FAQ, which can be navigated to via the menu by clicking on the entry labeled “View Question”. FIG. 23 displays an editing FAQ, which can be navigated to via the menu by clicking on the entry labeled “Ask/Edit Question”. FIG. 24 displays a membership FAQ, which can be navigated to via the menu by clicking on the entry “Membership Registration”. FIG. 25 displays a preferences FAQ, which can be navigated to via the menu by clicking on the entry labeled “Manage My Preferences”. FIG. 26 displays a community FAQ, which can be navigated to via the menu by clicking on the entry labeled “Community”. FIG. 27 displays a problem FAQ which can be navigated to via the menu by clicking on the entry labeled “Report a Problem”.

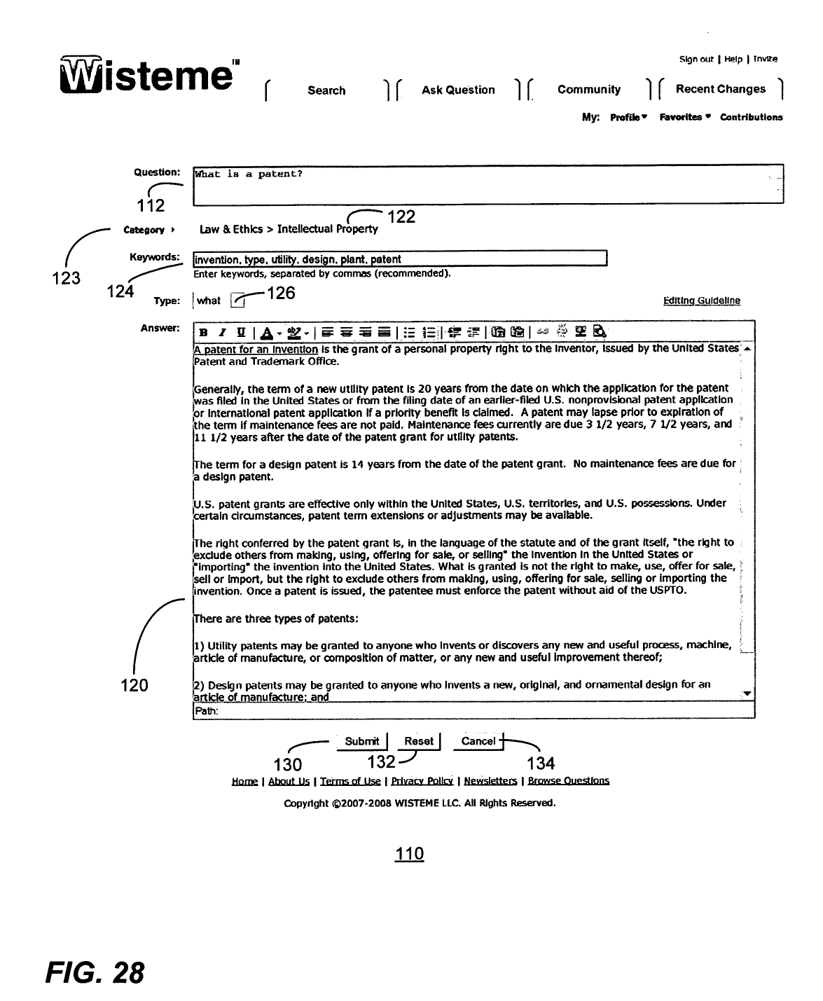

FIG. 28 is a screenshot of a web page of the open knowledge system represented in FIG. 4 that represents an exemplary editing page 110. As shown in FIG. 28, the editing page 110 includes a question edit box 112, an answer edit box 120, a category display field 122, a category expandable menu 123, a keywords edit field 124, a question type dropdown menu 126, a submit button 130, a reset button 132, and a cancel button 134.

The editing page 110 allows a user 80 to utilize the question edit box 112 to change the text of the question stored in the primary data component 12. When the user 80 first accesses the editing page 110, the text in the question edit box 112 is loaded from the primary data component 12 of the data structure 11 for a particular record. When the user 80 presses the submit button 130, the text in the question edit box 112 is processed.

The editing page 110 further allows the user 80 to utilize the answer edit box 120 to change the text of the answer stored in the informational content component 20 of the particular record. When the user 80 first accesses the editing page 110, the text in the answer edit box 120 is loaded from the informational content component 20 of the data structure 11 of the particular record. When the user 80 presses the submit button 130, the text in the answer edit box 120 is processed.

The editing page 110 further allows the user 80 to utilize the keyword edit field 124 to change the text of the keywords stored in the keywords component 24 of the data structure 11 of the particular record. When the user 80 first accesses the editing page 111, the text in the keywords edit field 124 is loaded from the keywords component 24 of the data structure 11 of the particular record. When the user 80 presses the submit button 130, the text in the keywords edit field 124 is processed.

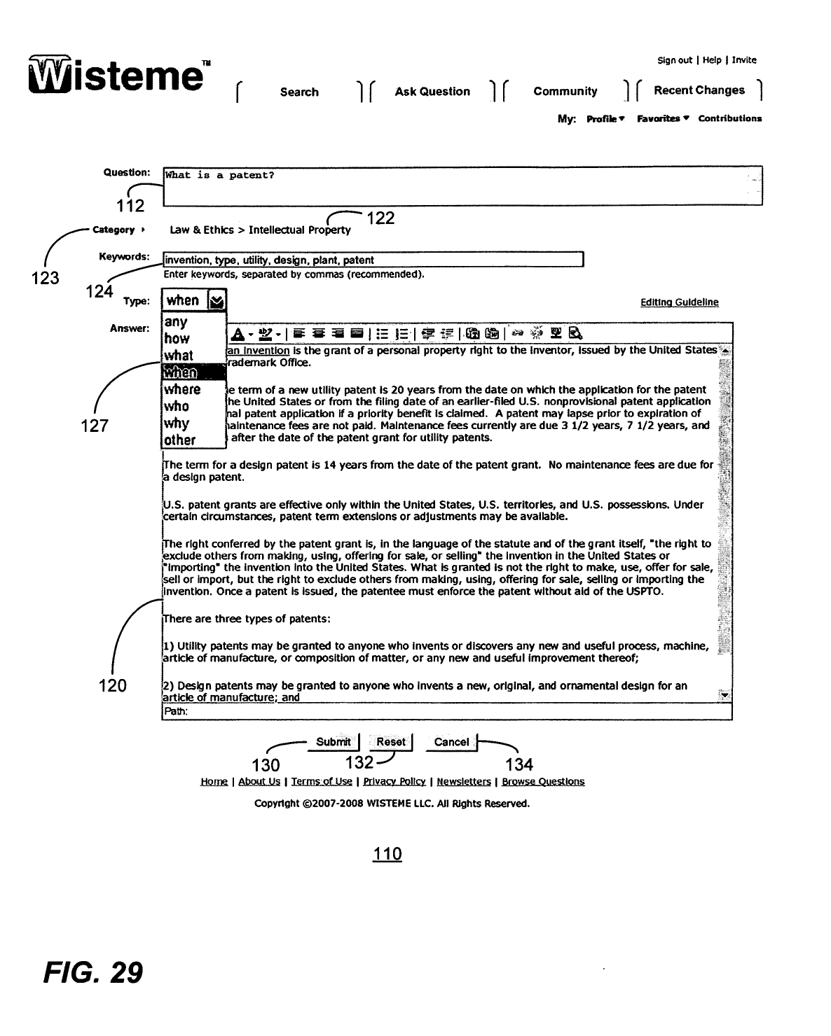

The editing page 110 further allows the user 80 to utilize the question type dropdown menu 126 to select an identifier to be stored in the question type component 26 of the data structure 11 of the particular record. When the user 80 first accesses the editing page 110, the identifier selected in the question type dropdown menu 126 is loaded from the question type component of the data structure 11 of the particular record. As can be seen in FIG. 29, when the user 80 clicks on the question type dropdown menu 126, a menu 127 drops down and allows the user 80 to select an identifier from the menu 127. When the user 80 presses the submit button 130, the identifier selected in the question type dropdown menu 126 is processed.

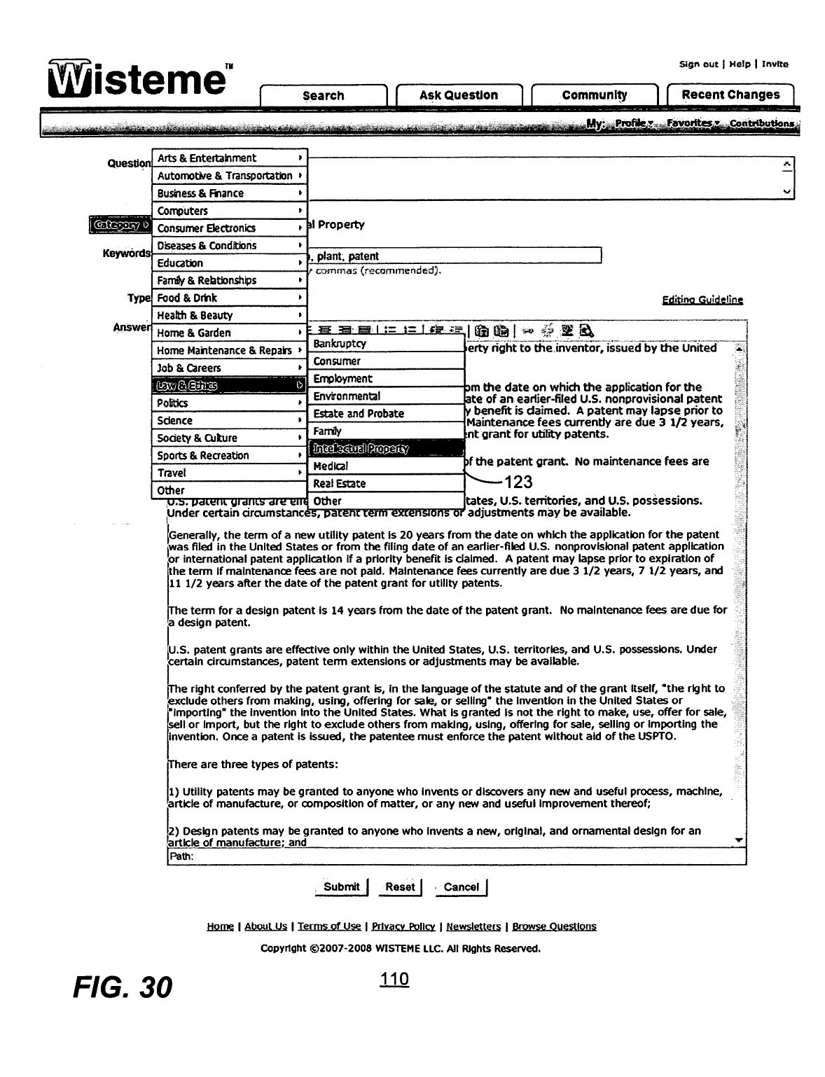

The editing page 110 further allows the user 80 to utilize the category expandable menu 123 to select an identifier to be stored in the category component 22 of the data structure 11 of the particular record. When the user 80 first accesses the editing page 110, the category identifier displayed in the category display field 122 is loaded from the category component 22 of the data structure 11 of the particular record. As can be seen in FIG. 30, when the user 80 mouses over the category expandable menu 123, the menu 123 expands allowing the user 80 to select an identifier from the menu 123. When the user clicks on an identifier, the menu 123 closes and the selected identifier is displayed in the category display field 122. When the user 80 presses the submit button 130, the identifier displayed in the category display field 122 is processed.

The editing page 110 further allows the user 80 to utilize the reset button 132, the cancel button 134, and the submit button 130. The reset button 132 undoes any user 80 changes that have not been saved by reloading in the screen the data previously stored both in the primary data component 12 and in the plurality of secondary data components 14 of the data structure 11 of the particular record. The cancel button 134 causes the user interface to navigate away from the editing page 110 without saving any changes. When the submit button 130 is pressed, processing begins as described below.

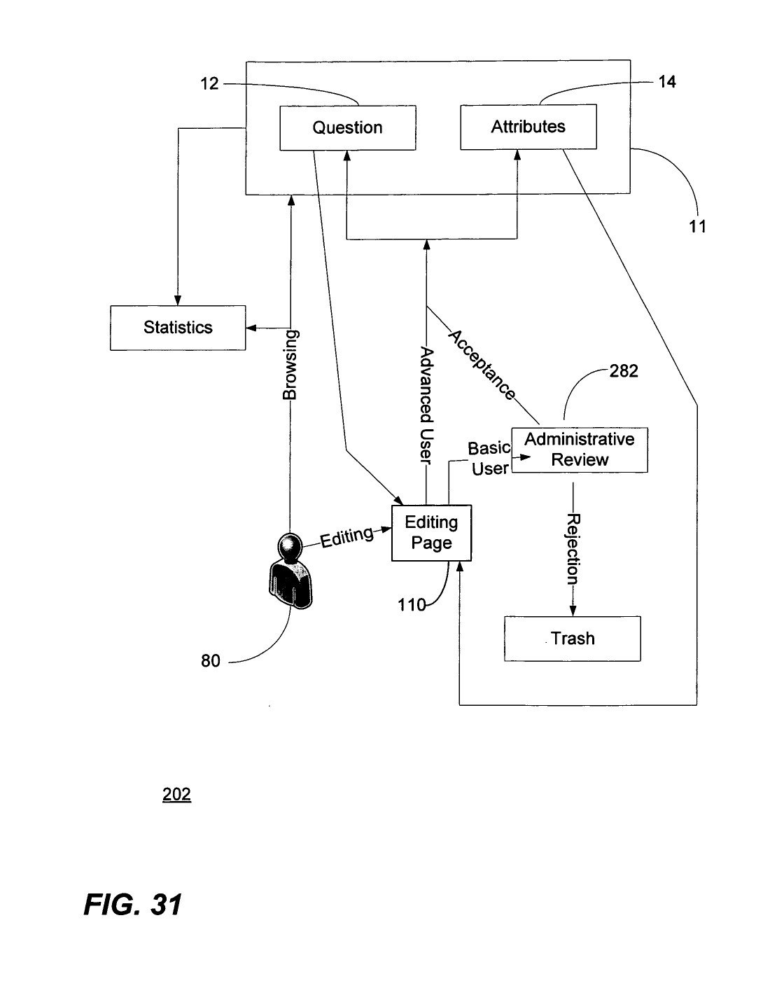

FIG. 31 is a diagram demonstrating possible paths of user interaction with an open knowledge system in accordance with the preferred embodiment of FIG. 2. Specifically, a user 80 is free to either browse the data contained in the open knowledge system, or else edit some data contained in the open knowledge system. If the user 80 chooses to browse the open knowledge system, then data regarding the user's 80 browsing will constantly be fed to a statistics collector which will compile and store statistics related to the user's 80 browsing.

If the user chooses to edit data contained in the open knowledge system, the user 80 will be taken to an editing page as represented by editing page 110 of FIGS. 28-30.

When the submit button 130 is pressed and processing begins, the system first determines whether the user 80 is an advanced user or a basic user. If the user 80 is an advanced user, then the data submitted by the user 80 is immediately saved to the respective portion of the data structure 11 of the particular record the user 80 chose to edit.

For example, if an advanced user utilizing the editing page 110 changed the text in the question edit box and then hit submit, the altered data would be immediately stored in the primary data component 12 of the data structure 11 of the particular record. If the user 80 is not an advanced user, then the data submitted is not immediately saved to the data structure of the particular record 11, but is instead saved to a review area 282, for consideration by administrative users. Administrative users will review the data that was submitted, and either accept its submission or else reject its submission. If the data submitted is accepted, then the data will be saved to the data structure 11 of the particular record the same as it would have been if the user was an advanced user. If, though, the submission is rejected, then the data will be cleared from the review area 282 and will not be saved.

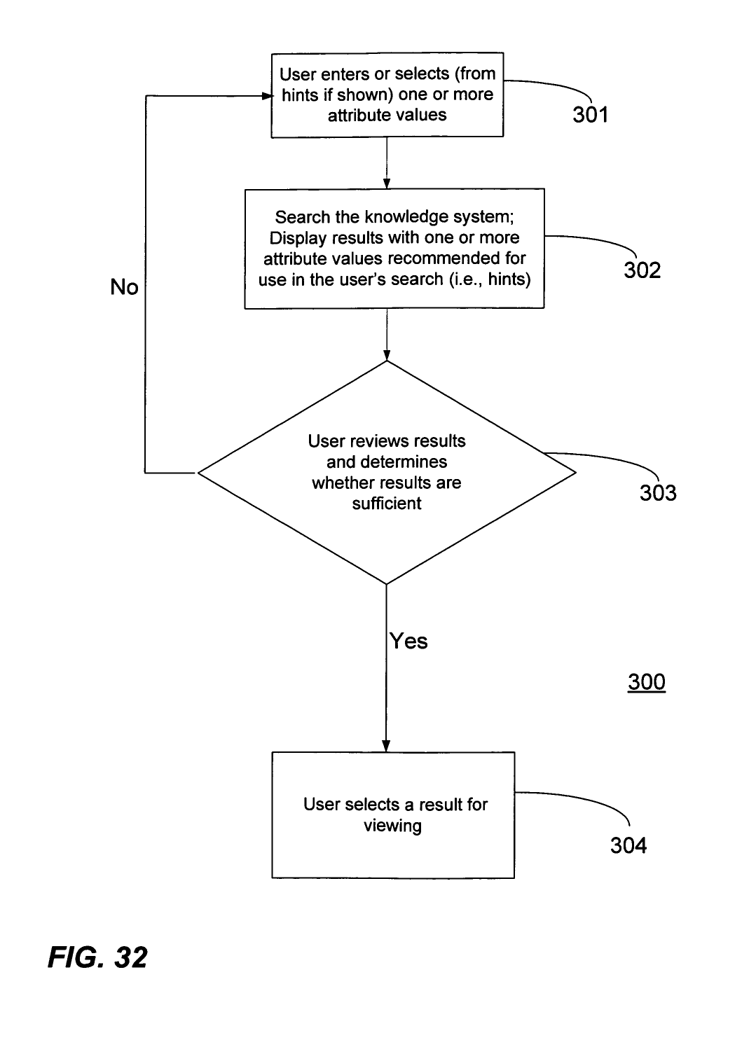

FIG. 32 is a flowchart of a method 300 of searching the open knowledge system represented in FIG. 4. First, at step 301, a user 80 enters or selects one or more attribute values to search for. At step 302, a search is then performed which compares the attribute values entered to attribute values stored in a multitude of records having data structure 11. Any particular records whose attribute values match those the user 80 searched for is considered a positive result. At step 303, information corresponding to each positive result is displayed to the user 80, along with hints pertaining to the attributes of at least one positive result. If none of the results are satisfactory to the user 80, then the user 80 may select or enter one of the displayed hints to refine his search. When the user 80 is satisfied with a result, he may select it for viewing at step 304.

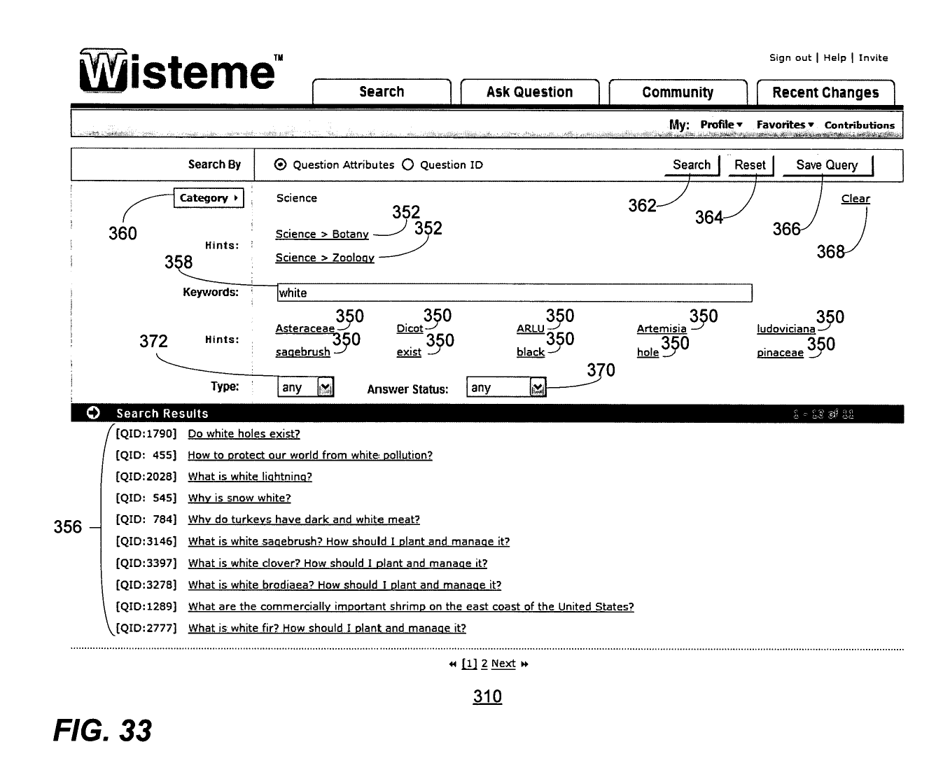

FIG. 33 is a screenshot of a search page 310 utilizing the method 300 of FIG. 32. On the search page 310, a user 80 may enter one or more keywords to search for in a keyword search edit field 358. A user 80 may additionally select a category from a category search expandable menu 360. A user 80 may select a question type from a question type dropdown menu 372. Lastly, a user 80 may choose to search for only those questions that have already been answered, or for all questions, by utilizing the answer status drop down menu 370. In the screenshot, the word “white” has been entered into the keyword search edit field 358, and the category “Science” has been selected from the category search expandable menu 360. The type dropdown menu 372 and answer status dropdown menu 370 are left at their defaults, so their respective attributes will not be a factor in this search.

After entering the desired search data into the search page 310, a user 80 presses a search button 362 to initiate a search. A search is performed utilizing a search algorithm, and any positive results 356 are displayed. Additionally, hints are provided to the user. As can be seen in FIG. 33, the user 80 is provided with category hints 352 and keyword hints 350. Any of these hints may be selected by the user 80 via a mouse-click. In this way, the user 80 may readily refine his search by selecting additional keywords with which to search, or a narrower category in which to search.

A reset button 364 clears all fields and restores the search page 310 to its default state. A clear button 368 returns the category expandable menu 360 to its default state, “All”, which indicates that any search performed will search all categories rather than just one specific category. A save query button 368 allows a user to save the data entered into the search page 310.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A method for an open knowledge system, comprising the steps of:
(a) providing, via network communications, access by users to the open knowledge system;
(b) searching the open knowledge system for informational content by comparing metadata in the open knowledge system with search data that is specified by the users, the metadata in the open knowledge system representing particular topics for which informational content is stored in the open knowledge system;
(c) presenting informational content for view by the users, the informational content resulting from the searching based on the comparison of the metadata with the user-specified search data; and
(d) enabling users to modify the metadata in the open knowledge system that represents the presented informational content resulting from the searching based on the comparison of the metadata with the user-specified search data,
whereby relevant informational content may be more readily viewed as a result of the searching of the open knowledge system by comparing metadata in the open knowledge system with user-specified search data.

2. The method of claim 1, wherein the metadata comprises a plurality of descriptors of the particular topic to which the viewed informational content pertains.

3. The method of claim 2, wherein users can both add and delete descriptors.

4. The method of claim 2, wherein a descriptor comprises a noun.

5. The method of claim 2, wherein a descriptor comprises a proper noun.

6. The method of claim 2, wherein a descriptor comprises a name.

7. The method of claim 2, wherein a descriptor comprises a URL.

8. The method of claim 2, wherein a descriptor comprises an address.

9. The method of claim 2, wherein a descriptor comprises an adjective.

10. The method of claim 1, further comprising the step of enabling users to modify informational content that is presented, whereby the presented informational content may be updated by users.

11. The method of claim 10, wherein users can modify informational content by uploading data representing the modified informational content.

12. The method of claim 1, wherein the particular topics are presented to users in the form of questions.

13. The method of claim 12, wherein the metadata comprises a plurality of descriptors, and wherein the descriptors comprise keywords of the question.

14. The method of claim 12, wherein informational content is presented to users in the form of answers.

15. The method of claim 14, wherein the metadata comprises a plurality of descriptors, the descriptors comprising both keywords of questions and keywords of answers.

16. The method of claim 1, further comprising computer-executable instructions in computer-readable medium for providing a user interface by which the plurality of users can add new records that are stored in the database, each new record having a data structure comprising a primary data component that is configured to store primary data of the new record, the primary data representing a particular topic; and a plurality of secondary data components, at least one of the secondary data components being configured to store informational content pertaining to the particular topic of the new record, and at least another of the secondary data components being configured to store metadata representing a plurality of descriptors of the particular topic of the new record.

17. The method of claim 1, wherein records stored in the database each further comprises a secondary data component configured to store data representing a unique database identification number logically associated with the record.

18. The method of claim 1, wherein records stored in the database each further comprises a secondary data component configured to store data representing a category of the particular topic of the record.

19. The method of claim 1, wherein records stored in the database each further comprises a secondary data component configured to store data representing primary data that was previously stored in the primary data component of the record but has since been modified or deleted.

20. The method of claim 1, wherein records stored in the database each further comprises a secondary data component configured to store data representing informational content pertaining to the particular topic of the record, which informational content has since been modified by a user.

21-52. (canceled)
